(19) United States
(12) Patent Application Publication
(10) Pub. No.: US 2026/0362191 A1
(43) Pub. Date: Nov. 12, 2026

(54) METHOD AND DEVICE FOR IMPROVED MEASUREMENT REPORTING FOR UNMANNED FLIGHT TERMINAL IN WIRELESS COMMUNICATION SYSTEM

(71) Applicant: Samsung Electronics Co., Ltd., Suwon-si, Gyeonggi-do (KR)

(72) Inventors: Jeongseok YU, Suwon-si (KR); Sangyeob JUNG, Suwon-si (KR)

(21) Appl. No.: 19/119,301

(22) PCT Filed: Oct. 31, 2023
(86) PCT No.: PCT/KR2023/017097

§ 371 Date: Apr. 8, 2025

(30) Foreign Application Priority Data
Nov. 3, 2022 (KR) 10-2022-0144899

(51) Int. Cl. H04W 24/10; H04B 17/318; H04W 8/22; H04W 84/06

(52) U.S. Cl. CPC H04W 24/10; H04B 17/328; H04W 8/22; H04W 84/06

(57) ABSTRACT

The present disclosure relates to a 5G or 6G communication system for supporting higher data transmission rates. The present disclosure relates to a 5G or 6G communication system for supporting higher data transmission rates. A method, according to an embodiment of the present disclosure, comprises receiving, from a base station, a first measurement configuration including information on a number of triggering cells satisfying an event to trigger measurement report; in case that the event is satisfied for at least on cell, performing the measurement report based on the information on the number of triggering cells; receiving, from the base station, a second measurement configuration including information indicating that the measurement reporting entry is not removed; and performing measurement based on the second measurement configuration, wherein the measurement reporting entry is not removed based on the information.

### TECHNICAL FIELD

The disclosure generally relates to a wireless communication system, and more particularly, to a method and device for improved measurement report for an unmanned flight terminal in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Problem

The present disclosure provides a method and device for transmitting a measurement reporting message for an unmanned flight terminal in a wireless communication system capable of more efficiently providing the measurement reporting message transmitted by the unmanned flight terminal.

The technical problems of the present disclosure are not limited to the above-described technical problems. That is, other technical problems that are not described may be obviously understood by those skilled in the art to which the present disclosure pertains from the following description.

### Technical Solution

According to an embodiment, a method performed by a terminal in a wireless communication system includes: receiving, from a base station, a first measurement configuration including information on a number of triggering cells satisfying an event to trigger measurement report; performing the measurement report based on the information on the number of triggering cells in case that the event is satisfied for at least one cell; receiving, from the base station, a second measurement configuration including information indicating that a measurement reporting entry is not removed; and performing measurement based on the second measurement configuration, in which the measurement reporting entry is not removed based on the information.

According to an embodiment, a method performed by a base station in a wireless communication system includes: transmitting, to a terminal, a first measurement configuration including information on a number of triggering cells satisfying an event to trigger measurement report; receiving, from the terminal, the measurement report based on the information on the number of triggering cells in case that the event is satisfied for at least one cell; and transmitting, to the terminal, a second measurement configuration including information indicating that a measurement reporting entry is not removed.

According to an embodiment, a terminal in a wireless communication system includes: a transceiver; and a controller coupled with the transceiver and configured to receive, from a base station, a first measurement configuration including information on a number of triggering cells satisfying an event to trigger measurement report, perform the measurement report based on the information on the number of triggering cells in case that the event is satisfied for at least one cell, receive, from the base station, a second measurement configuration including information indicating that a measurement reporting entry is not removed, and performs measurement based on the second measurement configuration, and the measurement reporting entry is not removed based on the information.

According to an embodiment, a base station in a wireless communication system includes: a transceiver; and a controller coupled with the transceiver and configured to transmit, to a terminal, a first measurement configuration including information on a number of triggering cells satisfying an event to trigger measurement report, receive, from the terminal, the measurement report based on the information on the number of triggering cells in case that the event is satisfied for at least one cell, and transmit, to the terminal, a second measurement configuration including information indicating that the measurement reporting entry is not removed.

### Advantageous Effects

According to an embodiment of the present disclosure, the base station may configure the list of cells that may be additionally considered in determining whether the terminal performs the measurement report. The terminal may simultaneously transmit the signal strength measurement results of the cells included in the list of cells configured by the base station and the signal strength measurement results of the cells not included in the list of cells configured by the base station.

Effects which can be achieved by the present disclosure are not limited to the above-described effects. That is, other effects that are not described may be obviously understood by those skilled in the art to which the present disclosure pertains from the following description.

### DESCRIPTION OF DRAWINGS

FIG. 1 is a diagram illustrating a structure of an LTE system according to an embodiment of the present disclosure.

FIG. 2 is a diagram illustrating a wireless protocol structure in an LTE system according to an embodiment of the present disclosure.

FIG. 3 is a diagram illustrating a structure of a next-generation mobile communication system according to an embodiment of the present disclosure.

FIG. 4 is a diagram illustrating a wireless protocol structure of the next-generation mobile communication system according to an embodiment of the present disclosure.

FIG. 5 is a diagram illustrating a procedure for an uncrewed aerial vehicle (UAV) UE to transmit a measurement report to a base station in the next-generation mobile communication system according to an embodiment of the present disclosure.

FIG. 6 is a diagram illustrating an example in which the efficiency of handover or interference mitigation is reduced when the UAV UE transmits the measurement report to the base station in the next-generation mobile communication system according to an embodiment of the present disclosure.

FIG. 7 is a diagram illustrating a process for the UAV UE to transmit a measurement report for a specific cell to the base station in the next-generation mobile communication system according to an embodiment of the present disclosure.

FIG. 8 is a diagram illustrating a process for the UAV UE to transmit improved measurement report to the base station in the next-generation mobile communication system according to an embodiment of the present disclosure.

FIG. 9 is a diagram illustrating a process for the UAV UE to effectively transmit the measurement report to the base station in the next-generation mobile communication system according to an embodiment of the present disclosure.

FIG. 10 is a diagram illustrating a process for the UAV UE to transmit a leaving condition-based measurement report to the base station in a next-generation mobile communication system according to an embodiment of the present disclosure.

FIG. 11 is a diagram illustrating a process for the UAV UE to transmit a leaving condition-based improved measurement report to the base station in the next-generation mobile communication system according to an embodiment of the present disclosure.

FIG. 12 is a diagram illustrating a process for the UAV UE to transmit a measurement report by a measurement reporting configuration change to the base station in the next-generation mobile communication system according to an embodiment of the present disclosure.

FIG. 13 is a diagram illustrating a process for the base station to transmit an improved measurement reporting configuration change to the UAV UE in the next-generation mobile communication system according to an embodiment of the present disclosure.

FIG. 14 is a diagram illustrating a process for the UAV UE to change reportOnLeave according to conditions in the next-generation mobile communication system according to an embodiment of the present disclosure.

FIG. 15 is a diagram illustrating a structure of a base station according to an embodiment of the present disclosure.

FIG. 16 is a diagram illustrating a structure of a terminal according to an embodiment of the present disclosure.

### MODE FOR DISCLOSURE

Hereinafter, embodiments of the present disclosure will be described in detail with reference to the accompanying drawings.

In describing the embodiments, descriptions of technical contents that are well known in the technical field to which the present disclosure pertains and are not directly related to the present disclosure will be omitted. This is to more clearly convey the gist of the present disclosure without ambiguity by omitting unnecessary descriptions.

For the same reason, some components in the accompanying drawings are exaggerated, omitted, or schematically illustrated. In addition, the size of each component does not entirely reflect the actual size. The same reference numerals are assigned to the same or corresponding components in each drawing.

Various advantages and features of the present disclosure and methods accomplishing the same will become apparent from the following detailed description of embodiments with reference to the accompanying drawings. However, the present disclosure is not limited to exemplary embodiments to be described below, but may be implemented in various different forms, the present embodiments will be provided only in order to make the present disclosure complete and allow those skilled in the art to completely recognize the scope of the present disclosure, and the present disclosure will be defined by the scope of the claims. Throughout the specification, the same components will be denoted by the same reference numerals. In addition, in describing the present disclosure, when it is determined that a detailed description for the related functions or configurations related to the present disclosure may unnecessarily obscure the gist of the present disclosure, the detailed description therefor will be omitted. Further, the following terminologies are defined in consideration of the functions in the present disclosure and may be construed in different ways by the intention of users and operators, practice, etc. Therefore, the definitions thereof should be construed based on the contents throughout the specification.

In describing embodiments of the present disclosure, main objects are new radio (NR), which is a wireless access network, and a packet core 5G system, or a 5G core network, or a next generation core (NG core), which is a core network, in the 5G mobile communication standard specified by the 3rd Generation Partnership Project (3GPP), a mobile communication standard standardization organization. However, the main gist of the present disclosure may be applied even to other communication systems having a similar technical background with slight modifications without significantly departing from the scope of the present disclosure, and this would be possible with the judgment of a person having technical knowledge skilled in the art of the present disclosure.

Hereinafter, for the convenience of description, some terms and names defined in the 3GPP standards (standards for 5G, NR, LTE, or similar systems) may be used. However, the present disclosure is not limited to the above terms and names, and may be equally applied to systems that follow other standards.

In the following description, terms for identifying connection nodes, terms referring to network entities, terms referring to messages, terms referring to interfaces between network entities, terms referring to various types of identification information, etc., are examples for the convenience of description. Therefore, the present disclosure is not limited to the terms described above, and other terms referring to objects having equivalent technical meanings may be used.

Hereinafter, a base station is an entity that performs resource allocation of a terminal, and may be at least one of a gNode B, an eNode B, a Node B, a base station (BS), a wireless access unit, a base station controller, or a node on a network. The terminal may include user equipment (UE), a mobile station (MS), a cellular phone, a smartphone, a computer, or a multimedia system capable of performing a communication function. In the present disclosure, downlink (DL) refers to a wireless transmission path of a signal that the base station transmits to the UE, and uplink (UL) refers to a wireless transmission path of a signal that the UE transmits to the base station.

In this case, it will be appreciated that each block of a processing flowchart and combinations of the flowcharts may be executed by computer program instructions. Since these computer program instructions may be mounted in a processor of a general computer, a special computer, or other programmable data processing apparatuses, these computer program instructions executed through the processor of the computer or the other programmable data processing apparatuses create means performing functions described in a block(s) of the flow chart. Since these computer program instructions may also be stored in a computer usable or computer readable memory that may direct a computer or other programmable data processing apparatuses in order to implement the functions in a specific scheme, the computer program instructions stored in the computer usable or computer readable memory can also produce manufacturing articles including instruction means performing the functions described in the block(s) of the flowchart. Since the computer program instructions may also be mounted on the computer or the other programmable data processing apparatuses, the instructions performing a series of operation steps on the computer or the other programmable data processing apparatuses to create processes executed by the computer, thereby executing the computer or the other programmable data processing apparatuses may also provide steps for performing the functions described in a block(s) of the flowchart.

In addition, each block may indicate some of modules, segments, or codes including one or more executable instructions for executing a specific logical function(s). Further, it is to be noted that functions mentioned in the blocks occur regardless of an order in some alternative embodiments. For example, two blocks that are continuously illustrated may be simultaneously performed in fact or be performed in a reverse order depending on corresponding functions.

In this case, the term ‘~unit’ used in the present embodiment refers to software or a hardware component such as a field programmable gate array (FPGA) or an application specific integrated circuit (ASIC), and ‘~unit’ play certain roles. However, ‘~unit’ is not limited to the software or the hardware. The ‘~unit’ may be configured to be stored in a storage medium that can be addressed or may be configured to reproduce one or more processors. Accordingly, as an example, the ‘~unit’ refers to components such as software components, object-oriented software components, class components, and task components, processes, functions, attributes, procedures, subroutines, segments of program code, drivers, firmware, microcode, circuits, data, databases, data structures, tables, arrays and variables. Components and functions provided within ‘~unit’ may be combined into a smaller number of components and ‘unit’ or may be further separated into additional components and ‘~unit’. Furthermore, components and ‘~units’ may be implemented to reproduce one or more central processing units (CPUs) in a device or a security multimedia card. In addition, in embodiments, the ‘~unit’ may include one or more processors.

5G mobile communication technology defines a wide frequency band to enable fast transmission speeds and new services, and can be implemented not only in a sub-6 GHz frequency band such as 3.5 gigahertz (3.5 GHz), but also in an ultra-high frequency band (‘above 6 GHz’) called millimeter wave (mmWave) such as 28 GHz and 39 GHz. In addition, in the case of 6G mobile communication technology, which is called systems beyond 5G communication, implementation in a terahertz band (e.g., 95 GHz to 3 terahertz (3 THz) band) is being considered to achieve a transmission speed that is 50 times faster than the 5G mobile communication technology and an ultra low latency time that is reduced by 1/10.

In the early stages of the 5G mobile communication technology, with the goal of ensuring service support and performance requirements for enhanced mobile broadband (eMBB), ultra-reliable low-latency communications (URLLC), and massive machine-type communications (mMTC), standardization has been made for beamforming and massive MIMO for mitigating a path loss of radio waves in a ultra-high frequency band and increase a transmission distance of the radio waves, support for various numerologies for efficient utilization of ultra-high frequency resources (operation of multiple subcarrier intervals, etc.) and dynamic operation of slot formats, initial access technology for supporting multi-beam transmission and broadband, definition and operation of a band-wide part (BWP), new channel coding methods, such as a low density parity check (LDPC) code for large-scale data transmission and a polar code for high reliable transmission of control information, L2 pre-processing, network slicing providing a dedicated network specialized for a specific service, etc.

Currently, discussions are underway for improvement and performance enhancement of the initial 5G mobile communication technology in consideration of services that the 5G mobile communication technology is intended to support, and physical layer standardization is in progress for technologies such as vehicle-to-everything (V2X) to help autonomous vehicles determine their driving based on their own locations and status information that the autonomous vehicles transmit and to increase user convenience, new radio unlicensed (NR-U) for system operation that meets various regulatory requirements in an unlicensed band, NR UE low power consumption technology (UE power saving), a non-terrestrial network (NTN) that is UE-satellite direct communication to secure coverage in areas where communication with a terrestrial network is impossible, and positioning.

In addition, standardization of wireless interface architecture/protocol fields is in progress for technologies such as industrial Internet of Things (IIoT) for supporting new services through linkage and convergence with other industries, integrated access and backhaul (IAB) that integrates and supports wireless backhaul links and access links to provide nodes for expanding network service areas, mobility enhancement including conditional handover and dual active protocol stack (DAPS) handover, and 2-step RACH for NR that simplifies random access procedures, and standardization of system architecture/service fields is also in progress for 5G baseline architecture (e.g., service based architecture, and service based interface) for combining network functions virtualization (NFV), software-defined networking (SDN) technology, mobile edge computing (MEC) that receives services based on a location of a UE, etc.

When such 5G mobile communication systems are commercialized, an explosive increase in connected devices will be connected to a communication network, so it is expected that improved functionality and performance of the 5G mobile communication systems and the integrated operation of the connected devices will be required. To this end, new researches are expected to be conducted on eXtended reality (XR) to efficiently support augmented reality (AR), virtual reality (VR), and mixed reality (MR), etc., improvement in 5G performance and reduction in complexity using artificial intelligence (AI) and machine learning (ML), AI service support, metaverse service support, drone communications, etc.

In addition, the development of these 5G mobile communication systems may serve as a basis for the development of not only multi-antenna transmission technology such as new waveform, full dimensional MIMO (FD-MIMO), array antenna, and large scale antenna to ensure coverage in the terahertz band of 6G mobile communication technology, high-dimensional spatial multiplexing technology using metamaterial-based lenses and antennas and orbital angular momentum (OAM) to improve the coverage of terahertz band signals, and reconfigurable intelligent surface (RIS) technology, but also full duplex technology for enhancing frequency efficiency and improving a system network of 6G mobile communication technology, AI-based communication technology that utilizes satellite and AI from the design stage and incorporates end-to-end AI support functions to realize system optimization, and next generation distributed computing technology that realizes services with complexity that exceeds the limits of UE computing capabilities by utilizing ultra-high-performance communication and computing resources, etc.

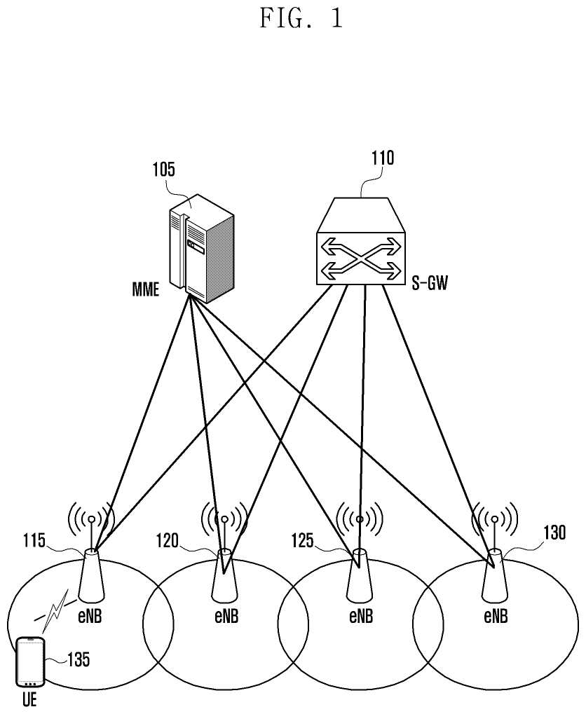

FIG. 1 is a diagram illustrating a structure of an LTE system according to an embodiment of the present disclosure.

Referring to FIG. 1, as illustrated, a wireless access network of an LTE system may be configured to include an LTE base station (evolved node B, hereinafter referred to as LTE eNB, eNB, or base station) 115, 120, 125, and 130, a mobility management entity (MME) 105, and a serving-gateway (S-GW) 110. A user terminal (hereinafter referred to as user equipment (UE) or terminal) 135 may access an external network through the eNB 115, 120, 125, and 130 and the S-GW 110.

In FIG. 1, the eNB 115, 120, 125, and 130 may correspond to a node B of a UMTS system. The eNB 115 is connected to the UE 135 through a wireless channel and may perform a more complex role than the Node B. In the LTE system, since all user traffic including real-time services such as voice over IP (VoIP) via the Internet protocol is served via a shared channel, a device that collects status information, such as a buffer status, an available transmission power status, and a channel status of the UEs, and performs scheduling is required, which may be handled by the eNBs 115, 120, 125, and 130. One eNB may usually control a plurality of cells. For example, in order to implement a transmission rate of 100 Mbps, the LTE system may use, for example, orthogonal frequency division multiplexing (OFDM) as a wireless access technology in a 20 MHz bandwidth. In addition, an adaptive modulation & coding (hereinafter, referred to as AMC) scheme that decides a modulation scheme and a channel coding rate may be applied according to the channel status of the UE. The S-GW 110 is an entity that provides a data bearer and may generate or remove the data bearer under the control of the MME 105. The MME 105 may be connected to a plurality of eNBs that are in charge of various control functions as well as mobility management functions for the UE.

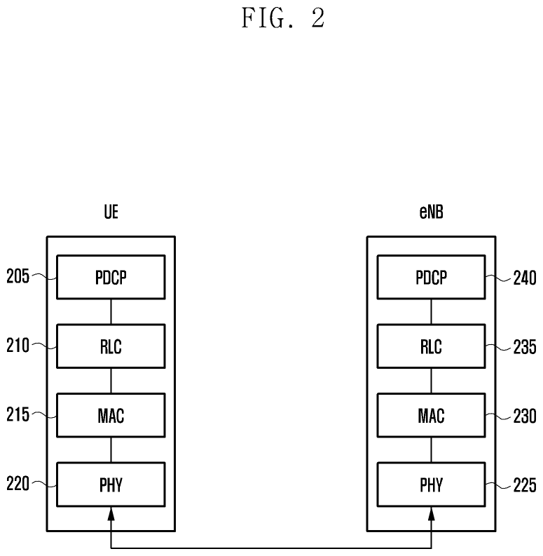

FIG. 2 is a diagram illustrating a wireless protocol structure in the LTE system according to an embodiment of the present disclosure.

Referring to FIG. 2, the wireless protocol of the LTE system is composed of packet data convergence protocols (PDCPs) 205 and 240, radio link controls (RLCs) 210 and 235, and medium access controls (MACs) 215 and 230 in the UE and the eNB, respectively. The PDCPs 205 and 240 may be in charge of operations such as IP header compression/reconstruction. The PDCP may include one or more of the following functions.
Header compression and decompression function (header compression and decompression)
User data transfer function (Transfer of user data)
In-sequence delivery function (in-sequence delivery of upper layer PDUs at PDCP re-establishment procedure for the RLC AM)
Reordering function (for split bearers in DC (only support for the RLC AM): PDCP PDU routing for transmission and PDCP PDU reordering for reception)
Duplicate detection function (Duplicate detection of lower layer SDUs at PDCP re-establishment procedure for the RLC AM)
Retransmission function (retransmission of PDCP SDUs at handover and, for split bearers in DC, of PDCP PDUs at the PDCP data-recovery procedure, for the RLC AM)
Ciphering and deciphering function (ciphering and deciphering)
Timer-based SDU discard function (timer-based SDU discard in uplink)

The RLC 210 and 235 may reconfigure a PDCP protocol data unit (PDCP PDU) to an appropriate size to perform an ARQ operation, etc. The RLC may include one or more of the following functions.
Data transfer function (transfer of upper layer PDUs)
ARQ function (error correction through ARQ (only for AM data transfer))
Concatenation, segmentation, and reassembly function (concatenation, segmentation and reassembly of the RLC SDUs (only for UM and AM data transfer))
Re-segmentation function (re-segmentation of RLC data PDUs (only for AM data transfer))
Reordering function (reordering of the RLC data PDUs (only for UM and AM data transfer))
Duplicate detection function (duplicate detection (only for UM and AM data transfer))
Error detection function (protocol error detection (only for AM data transfer))
RLC SDU discard function (RLC SDU discard (only for UM and AM data transfer))
RLC re-establishment (or re-configuration) function (RLC re-establishment)

The MACs 215 and 230 are connected to a plurality of RLC layer entities configured in one UE and may perform operations of multiplexing RLC PDUs into a MAC PDU and demultiplexing the RLC PDUs from the MAC PDU. The MAC may include one or more of the following functions.
Mapping function (MAPPING between logical channels and transport channels)
Multiplexing and demultiplexing function (multiplexing/demultiplexing of MAC SDUs belonging to one or different logical channels into/from transport blocks (TB) delivered to/from the physical layer on transport channels)
Scheduling information reporting function (scheduling information reporting)
HARQ function (error correction through HARQ)
Priority handling function between logical channels (priority handling between logical channels of one UE)
Priority handling function between UEs (priority handling between UEs by means of dynamic scheduling)
MBMS service identification function (MBMS service identification)
Transport format selection function (transport format selection)
Padding function (padding)

The physical layers 220 and 225 may perform an operation of channel coding and modulating higher layer data, converting the higher layer data into OFDM symbols and transmitting the OFDM symbols through a wireless channel, or demodulating and channel decoding the OFDM symbols received through the wireless channel, and transmitting the OFDM symbols to a higher layer.

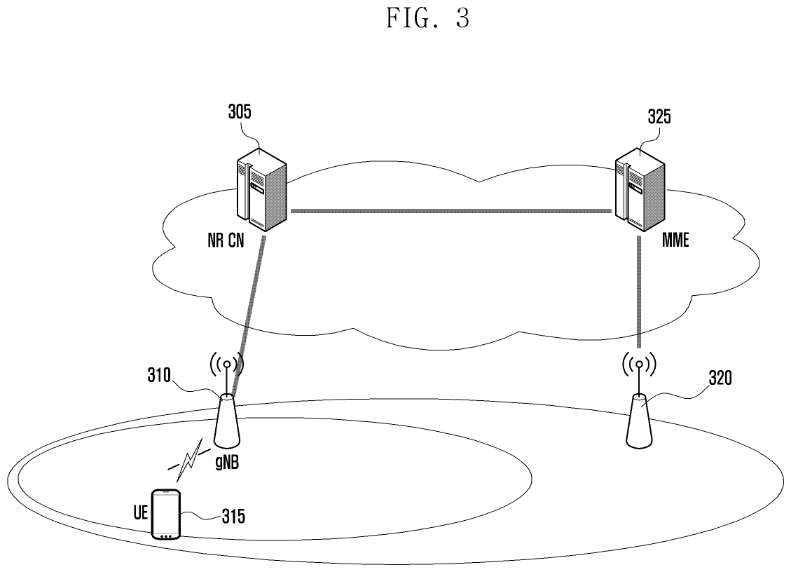

FIG. 3 is a diagram illustrating a structure of a next-generation mobile communication system according to an embodiment of the present disclosure.

Referring to FIG. 3, a wireless access network of a next-generation mobile communication system (hereinafter, referred to as NR or 5G) may be configured to include a next-generation base station (new radio node B, hereinafter referred to as NR gNB, gNB, or base station) 310 and a new radio core network (NR CN) 305. A user terminal (new radio user equipment, hereinafter, referred to as NR UE or UE) 315 may access an external network through the NR gNB 310 and the NR CN 305.

In FIG. 3, the NR gNB 310 may correspond to an eNB of an LTE system. The NR gNB is connected to the NR UE 315 via a wireless channel and may provide a service that is superior to the eNB. In the next-generation mobile communication system, since all user traffic is served through a shared channel, a device that collects status information such as a buffer status, an available transmission power status, and a channel status of UEs and performs scheduling is required, which may be handled by the NR gNB 310. One NR gNB may usually control a plurality of cells. In order to implement ultra-high-speed data transmission compared to the LTE, a bandwidth larger than a maximum bandwidth of the LTE may be used, and beamforming technology may be additionally incorporated with an OFDM scheme as a wireless access technology. In addition, an AMC scheme, which decides a modulation scheme and a channel coding rate according to the channel status of the UE, may be applied. The NR CN 305 may perform functions such as mobility support, bearer configuration, and QoS configuration. The NR CN is an entity that is in charge of various control functions as well as a mobility management function for the UE, and may be connected a plurality of base stations. In addition, the next-generation mobile communication system may be linked to the LTE system, and the NR CN 305 may be connected to an MME 325 via a network interface. The MME 325 may be connected to an eNB 320.

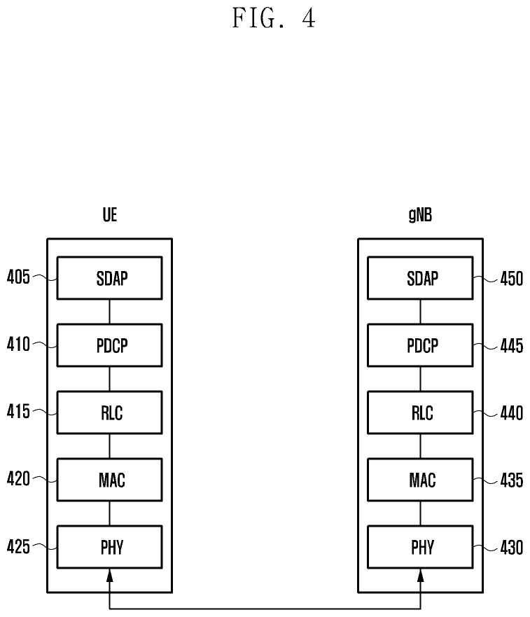

FIG. 4 is a diagram illustrating a wireless protocol structure of the next-generation mobile communication system according to an embodiment of the present disclosure.

Referring to FIG. 4, the wireless protocol of the next-generation mobile communication system may be composed of NR service data adaptation protocols (NR SDAPs) 405 and 450, NR PDCPs 410 and 445, NR RLCs 415 and 440, and NR MACs 420 and 435 in a UE and an NR base station, respectively.

NR SDAPs 405 and 450 may include one or more of the following functions.
User data transfer function (Transfer of user plane data)
Mapping function between QoS flow and DRB for both uplink and downlink (mapping between a QoS flow and a DRB for both DL and UL)
Marking function QoS flow ID in both uplink and downlink (marking QoS flow ID in both DL and UL packets)
Mapping reflective QoS flow to data bearers for uplink SDAP PDUs (reflective QoS flow to DRB mapping for the UL SDAP PDUs)

For the SDAP layer entity, the UE may be configured with whether to use a header of the SDAP layer entity or whether to use a function of the SDAP layer entity for each PDCP layer entity, each bearer, or each logical channel by an RRC message, and when the SDAP header is configured, the UE may instruct a NAS QoS reflection configuration 1-bit indicator (NAS reflective QoS) and an AS QoS reflection configuration 1-bit indicator (AS reflective QoS) of the SDAP header to update or reconfigure the mapping information for the QoS flow and data bearer of the uplink and downlink. The SDAP header may include QoS flow ID information indicating the QoS. The QoS information may be used as data processing priority, scheduling information, etc., to support seamless services.

The NR PDCPs 410 and 445 may include one or more of the following functions.
Header compression and decompression function (header compression and decompression: ROHC only)
User data transfer function (transfer of user data)
In-sequence delivery function (in-sequence delivery of upper layer PDUs)
Out-of-sequence delivery function (out-of-sequence delivery of upper layer PDUs)
Reordering function (pdcp pdu reordering for reception)
Duplicate detection function (duplicate detection of lower layer SDUs)
Retransmission function (retransmission of PDCP SDUs)
Ciphering and deciphering function (ciphering and deciphering)
Timer-based SDU discard function (timer-based SDU discard in uplink)

The reordering function of the NR RLC entity refers to a function of reordering RLC SDUs received from a lower layer in order based on a PDCP sequence number (PDCP SN). The reordering function may include a function of delivering data to a higher layer in the reordered order, include a function of delivering data directly without considering the order, include a function of recording lost PDCP PDUs by reordering the order, include a function of reporting a status of lost PDCP PDUs to a transmitting side, or include a function of requesting retransmission of the lost PDCP PDUs.

The NR RLCs 415 and 440 may include one or more of the following functions.
Data transfer function (transfer of upper layer PDUs)
In-sequence delivery function (in-sequence delivery of upper layer PDUs)
Out-of-sequence delivery function (out-of-sequence delivery of upper layer PDUs)
ARQ function (error correction through ARQ)
Concatenation, segmentation, and reassembly function (concatenation, segmentation and reassembly of RLC SDUs)
Re-segmentation function (re-segmentation of RLC data PDUs)
Reordering function (reordering of RLC data PDUs)
Duplicate detection function (duplicate detection)
Error detection function (protocol error detection)
RLC SDU discard function (RLC SDU discard)
RLC re-establishment function (RLC re-establishment)

The in-sequence delivery function of the NR RLC entity refers to the function of delivering the RLC SDUs received from the lower layer to the higher layer in order. The in-sequence delivery function may include a function of reassembling and delivering the segmented RLC SDUs when one RLC SDU is originally segmented into multiple RLC SDUs and received, include a function of reordering received RLC PDUs based on the RLC sequence number (RLC SN) or PDCP sequence number (PDCP SN), include a function of recording lost RLC PDUs by reordering the order, include a function of reporting a status of the lost RLC PDUs to a transmitting side, include a function of requesting retransmission of the lost RLC PDUs, include a function of delivering only RLC SDUs before the lost RLC SDU to the higher layer in order when there is the lost RLC SDU, include a function of delivering all RLC SDUs received before the timer is initiated to the higher layer in order if a given timer has expired even if there are the lost RLC SDUs, or include a function to deliver all the RLC SDUs received so far to the higher layer in order if a given timer has expired even if there are the lost RLC SDUs. In addition, the RLC PDUs may be processed in the order (in the order of arrival regardless of the order of the sequence number) that the RLC PDUs are received and delivered to the PDCP entity regardless of the order (out-of sequence delivery), or in case of segments, may be reconstructed into a single complete RLC PDU by receiving the segments stored in the buffer or to be received later, processed, and delivered to the PDCP entity. The NR RLC layer may not include the concatenation (or linkage) function, and perform the function in the NR MAC layer or be replaced by the multiplexing function of the NR MAC layer.

The out-of-sequence delivery function of the NR RLC entity described above refers to a function of directly delivering the RLC SDUs received from the lower layer to the higher layer regardless of the order. When one RLC SDU is originally segmented into the plurality of RLC SDUs and received, the out-of-sequence delivery function of the NR RLC entity may include a function of reassembling and delivering these RLC SDUs, and include a function of storing and ordering the RLC SN or the PDCP SN of the received RLC PDUs to record the lost RLC PDUs.

The NR MACs 420 and 435 may be connected to multiple NR RLC layer entities configured in one UE, and the NR MAC may include one or more of the following functions.
Mapping function (mapping between logical channels and transport channels)
Multiplexing/demultiplexing function (multiplexing/demultiplexing of MAC SDUs)
Scheduling information reporting function (scheduling information reporting)
HARQ function (error correction through HARQ)
Priority handling function between logical channels (priority handling between logical channels of one UE)
Priority handling function between UEs (priority handling between UEs by means of dynamic scheduling)
MBMS service identification function (MBMS service identification)
Transport format selection function (transport format selection)
Padding function (padding)

The NR PHY layers 425 and 430 may perform the operation of channel coding and modulating the higher layer data, converting the higher layer data into the OFDM symbols and transmitting the OFDM symbols through the wireless channel, or demodulating and channel decoding the OFDM symbols received through the wireless channel, and delivering the OFDM symbols to the higher layer.

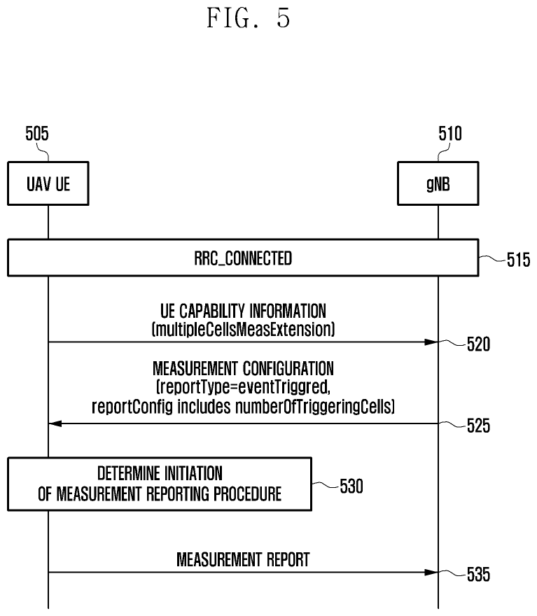

FIG. 5 is a diagram illustrating a procedure for an uncrewed aerial vehicle (UAV) UE to transmit a measurement report to a base station in the next-generation mobile communication system according to an embodiment of the present disclosure.

The UAV UE may operate at a higher location than a terrestrial UE and thus may have a longer line of sight than the terrestrial UE. Accordingly, the UAV UE may receive downlink (hereinafter, referred to as DL) interference from more cells than the terrestrial UE. That is, the UAV UE has a characteristic of receiving a high level of DL interference from more surrounding cells than the terrestrial UE. Similarly, the UAV UE has a characteristic of causing uplink (hereinafter, referred to as UL) interference from more cells than the terrestrial UE. In the present disclosure, a method for reporting a measurement report to a base station considering the characteristics of the UAV UE is proposed.

Referring to FIG. 5, a UAV UE 505 may establish an RRC connection with an NR base station 510 and thus may be in an RRC connected mode (RRC_CONNECTED) 515.

In step 520, the UE may transmit a UE capability information (UECapabilityInformation) message to the base station. The UE capability information message may include whether to support numberOfTriggeringCells (e.g., multipleCellsMeasExtension) that may be included in a measurement reporting configuration. multipleCellsMeasExtension may indicate whether the UE supports the capability to decide whether to transmit a measurement report based on the number of cells (numberOfTriggeringCells) configured by the base station. Alternatively, multipleCellsMeasExtension may define whether the UE supports the measurement report triggered based on the number of cells configured by the base station (This field defines whether the UE supports measurement report triggered based on a number of cells).

In step 525, the base station may transmit an RRC message (e.g., RRCResume or RRCReconfiguration) including measurement configuration information (MeasConfig) to the UE. In an embodiment, the measurement configuration information may include measurement object information (measObjectToAddModList) containing conditions for measurement objects, and include reporting configuration information (reportConfigToAddModList) that includes entering conditions, leaving conditions, or reporting conditions of a measurement event. measObjectToAddModList may be composed of one or more MeasObjectToAddMod, and each MeasObjectToAddMod may be configured as follows.

| | |
|---|---|
| MeasObjectToAddMod ::= | SEQUENCE { |
| measObjectId | MeasObjectId, |
| measObject | CHOICE { |
| measObjectNR | MeasObjectNR, |
| ..., | |
| measObjectEUTRA | MeasObjectEUTRA, |
| measObjectUTRA-FDD-r16 | MeasObjectUTRA-FDD-16, |
| measObjectNR-SL-r16 | MeasObjectNR-SL-r16, |
| measObjectCLI-r16 | MeasObjectCLI-r16, |
| measObjectRxTxDiff-r17 | MeasObjectRxTxDiff-r17, |
| measObjectRelay-r17 | SL-MeasObject-r16 |
| } | |
| } | |

| | |
|---|---|
| MeasObjectNR ::= | SEQUENCE { |

| | |
|---|---|
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |
| OPTIONAL, -- Cond IntraFreqConnected | |
| refFreqCSI-RS | ARFCN-ValueNR |
| OPTIONAL, Cond CSI-RS | |
| referenceSignalConfig | ReferenceSignalConfig, |
| absThreshSS-BlockaConsolidation | ThresholdNR |
| OPTIONAL, -- Need R | |
| absThreshCSI-RS-Consolidation | ThresholdNR |
| OPTIONAL, -- Need R | |
| nrofSS-BlocksToAverage | INTEGER (2..maxNrofSS-BlockaToAverage) |
| OPTIONAL, -- Need R | |
| nrofCSI-RS-ResourcesToAverage | INTEGER (2..maxNrofCSI-RS-ResourcesToAverage) |
| OPTIONAL, -- Need R | |
| quantityConfigIndex | INTEGER (1..maxNrofQuantityConfig), |
| offsetMO | Q-OffsetRangeList, |
| cellsToRemoveList | PCI-List |
| OPTIONAL, -- Need N | |
| cellsToAddModList | CellsToAddModList |
| OPTIONAL, -- Need N | |
| excludedCellsToRemoveList | PCI-RangeIndexList |
| OPTIONAL, -- Need N | |
| excludedCellsToAddModList | SEQUENCE (SIZE (1..maxNrofPCI-Ranges) ) OF PCI- |
| RangeElement OPTIONAL, -- Need N | |
| allowedCellsToRemoveList | PCI-RangeIndexList |
| OPTIONAL, -- Need N | |
| allowedCellstoAddModList | SEQUENCE (SIZE (1..maxNrofPCI-Ranges) ) OF PCI- |
| RangeElement OPTIONAL, -- Need N | |
| ..., | |
| [[ | |
| freqBandIndicatorNR | FreqBandIndicatorNR |
| OPTIONAL, -- Need R | |
| measCyclesCell | ENUMERATED {sf160, sf256, sf320, sf512, sf640, sf1024, |
| sf1280} OPTIONAL -- Need R | |
| ]], | |
| [[ | |
| smtc3list-r16 | SSB-MTC3List-r16 |
| OPTIONAL, -- Need R | |
| rmtc-Config-r16 | SetupRelease (RMTC-Config-r16) |
| OPTIONAL, -- Need M | |
| t312-r16 | SetupRelease ( T312-r16 ) |
| OPTIONAL -- Need M | |
| ]], | |
| [[ | |
| associatedMeasGapSSB-r17 | MeasGapId-r17 |
| OPTIONAL, -- Need R | |
| associatedMeasGapCSIRS-r17 | MeasGapId-r17 |
| OPTIONAL, -- Need R | |
| smtc4list-r17 | SSB-MTC4List-r17 |
| OPTIONAL, -- Need R | |
| measCyclePSCell-r17 | ENUMERATED {ms160, ms256, ms320, ms512, ms640, ms1024, |
| ms1280, spare1} | |
| OPTIONAL, -- Cond SCG | |
| cellsToAddModListExt-v1710 | CellsToAddModListExt-v1710 |
| OPTIONAL -- Need N | |
| ]], | |
| [[ | |
| associatedMeasGapSSB2-v1720 | MeasGapId-r17 |
| OPTIONAL, -- Cond AssociatedGapSSB | |
| associatedMeasGapCSIRS2-v1720 | MeasGapId-r17 |

OPTIONAL -- CondAssociatedGapCSIRS

]]
}

| | |
|---|---|
| SSB-MTC3List-r16::= | SEQUENCE (SIZE (1..4) ) OF SSB-MTC3-r16 |
| SSB-MTC4List-r17::= | SEQUENCE (SIZE (1..3) ) OF SSB-MTC4-r17 |
| T312-r16 ::= | ENUMERATED { ms0, ms50, ms100, ms200, ms300, ms400, ms500, |
| ms1000} | |
| ReferenceSignalConfig::= | SEQUENCE { |

| | |
|---|---|
| ssb-ConfigMobility | SSB-ConfigMobility |
| OPTIONAL, -- Need M | |
| csi-rs-ResourceConfigMobility | SetupRelease { CSI-RS-ResourceConfigMobility } |
| OPTIONAL -- Need M | |
| } | |

| | |
|---|---|
| SSB-ConfigMobility::= | SEQUENCE { |

| | |
|---|---|
| ssb-ToMeasure | SetupRelease { SSB-ToMeasure } |
| OPTIONAL, -- Need M | |
| deriveSSB-IndexFromCell | BOOLEAN, |
| ss-RSSI-Measurement | SS-RSSI-Measurement |
| OPTIONAL, -- Need M | |
| ..., | |
| [[ | |
| ssb-PositionQCL-Common-r16 | SSB-PositionQCL-Relation-r16 |
| OPTIONAL, -- Cond SharedSpectrum | |
| ssb-PositionQCL-CellsToAddModList-r16 | SSB-PositiongCL-CellsToAddModList-r16 |
| OPTIONAL, -- Need N | |
| ssb-PositionQCL-CellsToRemoveList-r16 | PCI-List |
| OPTIONAL Need N | |
| ]], | |
| [[ | |
| deriveSSB-IndexFromCellInter-r17 | ServCellIndex |
| OPTIONAL, -- Need R | |
| ssb-PositionQCL-Common-r17 | SSB-PositionQCL-Relation-r17 |
| OPTIONAL, -- Cond SharedSpectrum2 | |
| ssb-PositionQCL-Cells-r17 | SetupRelease {SSB-PositionQCL-CellList-r17} |
| OPTIONAL, -- Need M | |
| ]] | |
| } | |

| | |
|---|---|
| Q-OffsetRangeList ::= | SEQUENCE { |

| | | |
|---|---|---|
| rsrpOffsetSSB | Q-OffsetRange | DEFAULT dB0, |
| rsrqOffsetSSB | Q-OffsetRange | DEFAULT dB0, |
| sinrOffsetSSB | Q-OffsetRange | DEFAULT dB0, |
| rsrpOffsetCSI-RS | Q-OffsetRange | DEFAULT dB0, |
| rsrqOffsetCSI-RS | Q-OffsetRange | DEFAULT dB0, |
| sinrOffsetCSI-RS | Q-OffsetRange: | DEFAULT dB0 |
| } | | |

| | |
|---|---|
| ThresholdNR ::= | SEQUENCE { |

| | |
|---|---|
| thresholdRSRP | RSRP-Range |
| OPTIONAL, -- Need R | |
| thresholdRSRQ | RSRQ-Range |
| OPTIONAL, -- Need R | |
| thresholdSINR | SINR-Range |
| OPTIONAL -- Need R | |
| } | |

| | |
|---|---|
| CallsToAddModList | SEQUENCE (SIZE (1..maxNrofCellMeas) ) OF CellsToAddMod |
| CellToAddModListExt-v1710 ::= | SEQUENCE (SIZE (1..maxNrofCellMeas) ) OF CellsToAddModExt- |
| v1710 | |
| CellsToAddMod ::= | SEQUENCE { |

| | |
|---|---|
| physCellId | PhysCellId, |
| cellIndividualOffset | Q-OffsetRangeList |
| } | |

| | |
|---|---|
| CellsToAddModExt-v1710 ::= | SEQUENCE { |

| | |
|---|---|
| ntn-PolarizationDL-r17 | ENUMERATED {rhcp, lhcp, linear} |
| OPTIONAL, -- Need R | |
| ntn-PolarizationUL-r17 | ENUMERATED {rhcp, lhcp, linear} |
| OPTIONAL -- Need B | |
| } | |

| | |
|---|---|
| RMTC-Config-r16 ::= | SEQUENCE { |

| | |
|---|---|
| rmtc-Periodicity-r16 | ENUMERATED {ms40, ms80, ms160, ms320, mas640}, |
| rmtc-SubframeOffset-r16 | INTEGER (0..639) |
| OPTIONAL, -- Need M | |
| measDurationSymbols-r16 | ENUMERATED {sym1, sym14or12, sym28or24, sym42or36, |
| sym70or60}, | |
| rmtc-Frequency-r16 | ARFCN-ValueNR, |
| ref-SCS-CP-r16 | ENUMERATED {kHz15, kHz30, kHz60-NCP, kHz60-ECP}, |
| ..., | |
| [[ | |
| rmtc-Bandwidth-r17 | ENUMERATED {mhz100, mhz400, mhz800, mhz1600, mhz2000} |
| OPTIONAL, -- Need R | |
| measDurationSymbols-v1700 | ENUMERATED {sym140, sym560, sym1120} |
| OPTIONAL, -- Need R | |
| ref-SCS-CP-v1700 | ENUMERATED {kHz120, kHz480, kHz360} |
| OPTIONAL, -- Need R | |

| | |
|---|---|
| tci-StateInfo-r17 | SEQUENCE { |

| | |
|---|---|
| tci-StateId-r17 | TCI-StateId, |
| ref-ServCellId-r17 | ServCellIndex |
| OPTIONAL -- Need R | |
| } OPTIONAL -- Need R | |
| ]], | |
| [[ | |

| | |
|---|---|
| ref-BWPId-r17 | BWP-Id |

OPTIONAL -- Need R
]]
}

SSB-PositionQCL-CellsToAddModList-r16 ::= SEQUENCE (SIZE (1..maxNrofCellMeas) ) OF SSB-

PositionQCL-CellsToAddMod-r16

SSB-PositionQCL-CellsToAddMod-r16 ::= SEQUENCE {

| | |
|---|---|
| physCellId-r16 | PhysCellId, |
| ssb-PositionQCL-r16 | SSB-PositionQCL-Relation-r16 |
| } | |

SSB-PositionQCL-CellList-r17 ::= SEQUENCE (SIZE (1..maxNrofCellMeas) ) OF SSB-PositionQCL-Cell-r17

| | |
|---|---|
| SSB-PositionQCL-Cell-r17 | ::= SEQUENCE { |

| | |
|---|---|
| physCellId-r17 | PhysCellId, |
| ssb-PositionQCL-r17 | SSB-PositionQCL-Relation-r17 |
| } | |
| MeasObjectEUTRAN::= | SEQUENCE { |
| carrierFreq | ARFCN-ValueEUTRA, |
| allowedMeasBandwidth | EUTRA-AllowedMeasBandwidth, |
| cellsToRemoveListEUTRAN | EUTRA-CellIndexList |
| OPTIONAL, -- Need N | |
| cellsToAddModListEUTRAN | SEQUENCE (SIZE (1..maxCellMeasEUTRA) ) OF EUTRA- |
| Cell OPTIONAL, -- Need N | |
| excludedCellsToRemoveListEUTRAN | EUTRA-CellIndexList |
| OPTIONAL, -- Need N | |
| excludedCellsToAddModListEUTRAN | SEQUENCE (SIZE (1..maxCellMeasEUTRA) ) OF EUTRA- |
| ExcludedCell OPTIONAL, -- Need N | |
| eutra-PresenceAntennaPort1 | EUTRA-PresenceAntennaPort1, |
| eutra-Q-OftsetRange | EUTRA-Q-OffsetRange |
| OPTIONAL, -- Need R | |
| widebandRSRQ-Meas | BOOLEAN, |
| ..., | |
| [[ | |
| associatedMeasGap-r17 | MeasGapId-r17 |
| OPTIONAL -- Need R | |
| ]] | |
| } | |
| EUTRA-CellIndexList ::= | SEQUENCE (SIZE (1..maxCellMeasEUTRA) ) OF EUTRA- |
| CellIndex | |
| EUTRA-CellIndex ::= | INTEGER (1..maxCellMeasEUTRA) |
| EUTRA-Cell ::= | SEQUENCE { |
| cellIndexEUTRA | EUTRA-CellIndex, |
| physCellId | EUTRA-PhysCellId, |
| cellIndividualOffset | EUTRA-Q-OffsetRange |
| } | |
| EUTRA-Excludedcell ::= | SEQUENCE { |
| cellIndexEUTRA | EUTRA-CellIndex, |
| physCellIdRange | EUTRA-PhysCellIdRange |
| } | |

ReportConfigToAddModList may be composed of one or more ReportConfigToAddMod, and each ReportConfigToAddMod may be configured as follows:

| ReportConfigToAddMod ::= | SEQUENCE { | |
|---|---|---|
| reportConfigId | ReportConfigId, | |
| reportConfig | CHOICE { | |
| reportConfigNR | ReportConfigNR, | |
| ..., | | |
| reportConfigInterRAT | ReportConfigInterRAT, | |
| reportConfigNR-SL-r16 | ReportConfigNR-SL-r16 | |
| } | | |
| } | | |
| ReportConfigNR ::= | SEQUENCE { | |
| reportType | CHOICE { | |
| periodical | PeriodicalReportConfig, | |
| eventTriggered | EventTriggerConfig, | |
| ..., | | |
| reportCGI | ReportCGI, | |
| reportSFTD | ReportedSFTD-NR, | |
| condTriggerConfig-r16 | CondTriggerConfig-r16, | |
| cli-Periodical-r16 | CLI-PeriodicalReportConfig-r16, | |
| cli-EventTriggered-r16 | CLI-EventTriggeredConfig-r16, | |
| rxTxPeriodical-r17 | RxTxPeriodical-r17 | |
| } | | |
| } | | |
| ReportCGI ::= | SEQUENCE { | |
| cellForWhichToReportCGI | PhysCellId, | |
| ..., | | |
| [[ | | |
| useAutonomousGaps-r16 | ENUMERATED {setup} | OPTIONAL -- Need R |
| ]] | | |
| } | | |
| ReportSFTD-NR ::= | SEQUENCE { | |
| reportSFTD-Meas | BOOLEAN, | |
| reportRSRP | BOOLEAN, | |
| ..., | | |
| [[ | | |
| reportSFTD-NeighMeas | ENUMERATED {true} | OPTIONAL, |
| -- Need R | | |
| drx-SFTD-NeighMeas | ENUMERATED {true} | OPTIONAL, |
| -- Need R | | |
| cellsForWhichToReportSFTD | SEQUENCE (SIZE (1..maxCellSFTD) ) OF PhysCellId | OPTIONAL |
| -- Need R | | |
| ]] | | |
| } | | |
| CondTriggerConfig-r16 ::= | SEQUENCE { | |
| condEventId | CHOICE { | |
| condEventA3 | SEQUENCE { | |
| a3-Offset | MeasTriggerQuantityOffet, | |
| hysteresis | Hysteresis, | |
| timeToTrigger | TimeToTrigger | |
| }, | | |
| condEventA5 | SEQUENCE { | |
| a5-Threshold1 | MeasTriggerQuantity, | |
| a5-Threshold2 | MeasTriggerQuantity, | |
| hysteresis | Hysteresis, | |
| timeToTrigger | TimeToTrigger | |
| }, | | |
| ..., | | |
| condEventA4-r17 | SEQUENCE { | |
| a4-Threshold-r17 | MeasTriggerQuantity, | |
| hysteresis-r17 | Hysteresis, | |
| timeToTrigger-r17 | TimeToTrigger | |
| }, | | |
| condEventD1-r17 | SEQUENCE { | |
| distanceThreshFromReference1-r17 | INTEGER(0.. 65525), | |
| distanceThreshFromReference2-r17 | INTEGER(0.. 65525), | |
| referenceLocation1-r17 | ReferenceLocation-r17, | |
| referenceLocation2-r17 | ReferenceLocation-r17, | |
| hysteresisLocation1-r17 | HysteresisLocation-r17, | |
| timeToTrigger-r17 | TimeToTrigger | |
| }, | | |
| condEventT1-r17 | SEQUENCE { | |
| t1-Threshold-r17 | INTEGER (0..549755813887), | |
| duration-r17 | INTEGER (1..6000) | |
| } | | |
| }, | | |
| rsType-r16 | NR-RS-Type, | |
| ... | | |
| } | | |
| EventTriggerConfig::= | SEQUENCE { | |
| eventId | CHOICE { | |
| eventA1 | SEQUENCE { | |
| a1-Threshold | MeasTriggerQuantity, | |
| reportOnLeave | BOOLEAN, | |
| hysteresis | Hysteresis, | |
| timeToTrigger | TimeToTrigger, | |
| }, | | |
| eventA2 | SEQUENCE { | |
| a2-Threshold | MeasTriggerQuantity, | |
| reportOnLeave | BOOLEAN, | |
| hysteresis | Hysteresis, | |
| timeToTrigger | TimeToTrigger, | |
| }, | | |
| eventA3 | SEQUENCE { | |
| a3-Threshold | MeasTriggerQuantity, | |
| reportOnLeave | BOOLEAN, | |
| hysteresis | Hysteresis, | |
| timeToTrigger | TimeToTrigger, | |
| useAllowedCellList | BOOLEAN | |
| }, | | |
| eventA4 | SEQUENCE { | |
| a4-Threshold | MeasTriggerQuantity, | |
| reportOnLeave | BOOLEAN, | |
| hysteresis | Hysteresis, | |
| timeToTrigger | TimeToTrigger, | |
| useAllowedCellList | BOOLEAN | |
| }, | | |
| eventA5 | SEQUENCE { | |
| a5-Threshold1 | MeasTriggerQuantity, | |
| a5-Threshold2 | MeasTriggerQuantity, | |
| reportOnLeave | BOOLEAN, | |
| hysteresis | Hysteresis, | |
| timeToTrigger | TimeToTrigger, | |
| useAllowedCellList | BOOLEAN | |
| }, | | |
| eventA6 | SEQUENCE { | |
| a6-Offset | MeasTriggerQuantityOffset, | |
| reportOnLeave | BOOLEAN, | |
| hysteresis | Hysteresis, | |
| timeToTrigger | TimeToTrigger, | |
| useAllowedCellList | BOOLEAN | |
| }, | | |
| ..., | | |
| [[ | | |
| eventX1-r17 | SEQUENCE { | |
| x1-Threshold1-Relay-r17 | SL-MeasTriggerQuantity-r16, | |
| x1-Threshold2-r17 | MeasTriggerQuantity, | |
| reportOnLeave-r17 | BOOLEAN, | |
| hysteresis-r17 | Hysteresis, | |
| timeToTrigger-r17 | TimeToTrigger, | |
| useAllowedCellList-r17 | BOOLEAN | |
| }, | | |
| eventX2-r17 | SEQUENCE { | |
| x2-Threshold1-Relay-r17 | SL-MeasTriggerQuantity-r16, | |
| reportOnLeave-r17 | BOOLEAN, | |
| hysteresis-r17 | Hysteresis, | |
| timeToTrigger-r17 | TimeToTrigger, | |
| }, | | |
| eventD1-r17 | SEQUENCE { | |
| distanceThreshFromReference1-r17 | INTEGER(1.. 65525), | |
| distanceThreshFromReference2-r17 | INTEGER(1.. 65525), | |
| referenceLocation1-r17 | ReferenceLocation-r17, | |
| referenceLocation2-r17 | ReferenceLocation-r17, | |
| reportOnLeave-r17 | BOOLEAN, | |
| hysteresisLocation-r17 | HysteresisLocation-r17, | |
| timeToTrigger-r17 | TimeToTrigger | |
| } | | |
| ]] | | |
| }, | | |
| rsType | NR-RS-Type, | |
| reportInterval | ReportInterval, | |
| reportAmount | ENUMERATED {r1, r2, r4, r8, r16, r32, r64, | |
| infinity}, | | |
| reportQuantityCell | MeasReportQuantity, | |
| maxReportCells | INTEGER (1..maxCellReport), | |
| reportQuantityRS-Indexes | MeasReportQuantity | |
| OPTIONAL, -- Need R | | |
| maxNrofRS-IndexesToReport | INTEGER (1..maxNrofIndexesToReport) | |
| OPTIONAL, -- Need R | | |
| includeBeamMeasurements | BOOLEAN, | |
| reportAddNeighMeas | ENUMERATED {setup} | |
| OPTIONAL, -- Need R | | |
| ..., | | |
| [[ | | |
| measRSSI-ReportConfig-r16 | MeasRSSI-ReportConfig-r16 | |
| OPTIONAL, -- Need R | | |
| useT312-r16 | BOOLEAN | |
| OPTIONAL, -- Need M | | |
| includeCommonLocationInfo-r16 | ENUMERATED {true} | |
| OPTIONAL, -- Need R | | |
| includeBT-Meas-r16 | SetupRelease (BT-NameList-r16) | |
| OPTIONAL, -- Need M | | |
| includeWLAN-Meas-r16 | SetupRelease (WLAN-NameList-r16) | |
| OPTIONAL, -- Need M | | |
| includeSensor-Meas-r16 | SetupRelease (Sensor-NameList-r16) | |
| OPTIONAL, -- Need M | | |
| ]], | | |
| [[ | | |
| coarseLocationRequest-r17 | ENUMERATED {true} | |
| OPTIONAL, -- Need R | | |
| reportQuantityRelay-r17 | SL-MeasReportQuantity-r16 | |
| OPTIONAL, -- Need R | | |
| ]] | | |
| } | | |
| \|PeriodocalReportConfig ::= | SEQUENCE { | |
| rsType | NR-RS-Type, | |
| reportInterval | ReportInterval, | |
| reportAmount | ENUMERATED {r1, r2, r4, r8, r16, r32, r64, | |
| infinity}, | | |
| reportQuantityCell | MeasReportQuantity, | |
| maxReportCells | INTEGER (1..maxCellsReport), | |
| reportQuantityRS-Indexes | MeasReportQuantity | |
| OPTIONAL, -- Need R | | |
| maxNrofRS-IndexesToReport | INTEGER (1..maxNrofIndexesToReport) | |
| OPTIONAL, -- Need R | | |
| includeBeamMeasurements | BOOLEAN, | |
| useAllowedCellList | BOOLEAN, | |
| ..., | | |
| [[ | | |
| measRSSI-ReportConfig-r16 | MeasRSSI-ReportConfig-r16 | |
| OPTIONAL, -- Need R | | |
| includeCommonLocationInfo-r16 | ENUMERATED {true} | |
| OPTIONAL, -- Need R | | |
| includeBT-Meas-r16 | SetupRelease (BT-NameList-r16) | |
| OPTIONAL, -- Need M | | |
| includeWLAN-Meas-r16 | SetupRelease (WLAN-NameList-r16) | |
| OPTIONAL, -- Need M | | |
| includeSensor-Meas-r16 | SetupRelease (Sensor-NameList-r16) | |
| OPTIONAL, -- Need M | | |
| ul-DelayValueConfig-r16 | SetupRelease ( UL-DelayValueConfig-r16 ) | |
| OPTIONAL, -- Need M | | |
| reportAddNeighMeas-r16 | ENUMERATED {setup} | |
| OPTIONAL, -- Need R | | |
| ]], | | |
| [[ | | |
| ul-ExcessDelayConfig-r17 | SetupRelease ( UL-ExcessDelayConfig-r17 ) | |
| OPTIONAL, -- Need M | | |
| coarseLocationRequest-r17 | ENUMERATED {true} | |
| OPTIONAL, -- Need R | | |
| reportQuantityRelay-r17 | SL-MeasReportQuantity-r16 | |
| OPTIONAL, -- Need R | | |
| ]] | | |
| } | | |
| NR-RS-Type ::= | ENUMERATED {ssb, csi-rs} | |
| MeasTriggerQuantity ::= | CHOICE { | |
| rsrp | RSRP-Range, | |
| rsrq | RSRQ-Range | |
| sinr | SINR-Range | |
| } | | |
| MeasTriggerQuantityOffset ::= | CHOICE { | |
| rsrp | INTEGER (−30..30), | |
| rsrq | INTEGER (−30..30), | |
| sinr | INTEGER (−30..30) | |
| } | | |
| MeasReportQuantity ::= | SEQUENCE { | |
| rsrp | BOOLEAN, | |
| rsrq | BOOLEAN, | |
| sinr | BOOLEAN | |
| } | | |
| MeasRSSI-ReportConfig-r16 ::= | SEQUENCE { | |
| channelOccupancyThreshold-r16 | RSSI-Range-r16 | OPTIONAL -- Need R |
| } | | |
| CLI-EventTriggerConfig-r16 ::= | SEQUENCE { | |
| eventId-r16 | CHOICE { | |
| eventI1-r16 | SEQUENCE { | |
| i1-Threshold-r16 | MeasTriggerQuantityCLI-r16, | |
| reportOnLeave-r16 | BOOLEAN, | |
| hysteresis-r16 | Hysteresis, | |
| timeToTrigger-r16 | TimeToTrigger | |
| }, | | |
| ... | | |
| }, | | |
| reportInterval-r16 | ReportInterval, | |
| reportAmount-r16 | ENUMERATED {r1, r2, r4, r8, r16, r32, r64, | |
| infinity}, | | |
| maxReportCLI-r16 | INTEGER (1..maxCLI-Report-r16), | |
| ... | | |
| } | | |
| CLI-PeriodicalReportConfig-r16 ::= | SEQUENCE { | |
| reportInterval-r16 | ReportInterval, | |
| reportAmount-r16 | ENUMERATED {r1, r2, r4, r8, r16, r32, r64, | |
| infinity}, | | |
| reportQuantityCLI-r16 | MeasReportQuantityCLI-r16, | |
| maxReportCLI-r16 | INTEGER (1..maxCLI-Report-r16), | |
| ... | | |
| } | | |
| RxTxPeriodical-r17 ::= | SEQUENCE { | |
| rxTxReportInterval-r17 | RxTxReportInterval-r17 | |
| OPTIONAL, --Need R | | |
| reportAmount-r17 | ENUMERATED {r1, infinity, spare6, spare5, spare4, | |
| spare3, spare2, spare1}, | | |
| ... | | |
| } | | |
| RxTxReportInterval-r17 ::= ENUMERATED | | |

{ms80,ms120,ms160,ms240,ms320,ms480,ms640,ms1024,ms1280,ms2048,ms2560,ms5120,spare4,spare3,spare2

| ,spare1} | | |
|---|---|---|
| MeasTriggerQuantityCLI-r16 ::= | CHOICE { | |
| srs-RSRP-r16 | SRS-RSRP-Range-r16, | |
| cli-RSSI-r16 | CLI-RSSI-Range-r16 | |
| } | | |
| MeasReportQuantityCLI-r16 ::= | ENUMERATED {srs-rsrp, cli-rssi} | |
| ReportConfigInterRAT ::= | SEQUENCE { | |
| reportType | CHOICE { | |
| periodical | PeriodicalReportConfigInterRAT, | |
| eventTriggered | EventTriggerConfigInterRAT, | |
| reportCGI | ReportCGI-EUTRA, | |
| ..., | | |
| reportSFTD | ReportSFTD-EUTRA | |
| } | | |
| } | | |
| ReportCGI-EUTRA ::= | SEQUENCE { | |
| cellForWhichToReportCGI | EUTRA-PhysCellId, | |
| ..., | | |
| [[ | | |
| useAutonomousGaps-r16 | ENUMERATED {setup} | OPTIONAL -- Need R |
| ]] | | |
| } | | |
| ReportSFTD-EUTRA ::= | SEQUENCE { | |
| reportSFTD-Meas | BOOLEAN, | |
| reportRSRP | BOOLEAN, | |
| ... | | |
| } | | |
| EventTriggerConfigInterRAT ::= | SEQUENCE { | |
| eventId | CHOICE { | |
| eventB1 | SEQUENCE { | |
| b1-ThresholdEUTRA | MeasTriggerQuantityEUTRA, | |
| reportOnLeave | BOOLEAN, | |
| hysteresis | Hysteresis, | |
| timeToTrigger | TimeToTrigger, | |
| ... | | |
| }, | | |
| eventB2 | SEQUENCE { | |
| b2-Threshold1 | MeasTriggerQuantity, | |
| b2-Threshold2EUTRA | MeasTriggerQuantityEUTRA, | |
| reportOnLeave | BOOLEAN, | |
| hysteresia | Hysteresis, | |
| timeToTrigger | TimeToTrigger, | |
| ... | | |
| }, | | |
| ..., | | |
| [[ | | |
| eventB1-UTRA-FDD-r16 | SEQUENCE { | |
| b1-ThresholdUTRA-FDD-r16 | MeasTriggerQuantityUTRA-FDD-r16, | |
| reportOnLeave-r16 | BOOLEAN, | |
| hysteresis-r16 | Hysteresis, | |
| timeToTrigger-r16 | TimeToTrigger, | |
| ... | | |
| }, | | |
| eventB2-UTRA-FDD-r16 | SEQUENCE { | |
| b2-Threshold1-r16 | MeasTriggerQuantity, | |
| b2-Threshold2UTRA-FDD-r16 | MeasTriggerQuantityUTRA-FDD-r16, | |
| reportOnLeave-r16 | BOOLEAN, | |
| hysteresis-r16 | Hysteresis, | |
| timeToTrigger-r16 | TimeToTrigger, | |
| ... | | |
| } | | |
| ]], | | |
| [[ | | |
| eventY1-Relay-r17 | SEQUENCE { | |
| y1-Threshold1-r17 | MeasTriggerQuantity, | |
| y1-Threshold2-Relay-r17 | SL-MeasTriggerQuantity-r16, | |
| reportOnLeave-r17 | BOOLEAN, | |
| hysteresis-r17 | Hysteresis, | |
| timeToTrigger-r17 | TimeToTrigger, | |
| ... | | |
| }, | | |
| eventY2-Relay-r17 | SEQUENCE { | |
| y2-Threshold-Relay-r17 | SL-MeasTriggerQuantity-r16, | |
| reportOnLeave-r17 | BOOLEAN, | |
| hysteresis-r17 | Hysteresis, | |
| timeToTrigger-r17 | TimeToTrigger, | |
| ... | | |
| } | | |
| ]] | | |
| }, | | |
| reType | NR-RS-Type, | |
| reportInterval | ReportInterval, | |
| reportAmount | ENUMERATED {r1, r2, r4, r8, r16, r32, r64, infinity}, | |
| reportQuantity | MeasReportQuantity, | |
| maxReportCells | INTEGER (1..maxCellReport), | |
| ..., | | |
| [[ | | |
| reportQuantityUTRA-FDD-r16 | MeasReportQuantityUTRA-FDD-r16 | OPTIONAL -- Need |
| R | | |
| ]], | | |
| [[ | | |
| includeCommonLocationInfo-r16 | ENUMERATED {true} | |
| OPTIONAL, -- Need R | | |
| includeBT-Meas-r16 | SetupRelease {BT-NameList-r16} | |
| OPTIONAL, -- Need M | | |
| includeWLAN-Meas-r16 | SetupRelease (WLAN-NameList-r16) | |
| OPTIONAL, -- Need M | | |
| includeSensor-Meas-r16 | SetupRelease (Sensor-NameList-r16) | |
| OPTIONAL -- Need M | | |
| ]], | | |
| [[ | | |
| reportQuantityRelay-r17 | SL-MeasReportQuantity-r16 | |
| OPTIONAL -- Need R | | |
| ]]} | | |
| PeriodicalReportConfigInterRAT ::= | SEQUENCE { | |
| reportInterval | ReportInterval, | |
| reportAmount | ENUMERATED {r1, r2, r4, r8, r16, r32, r64, | |
| infinity}, | | |
| reportQuantity | MeasReportQuantity, | |
| maxReportCells | INTEGER (1..maxCellReport), | |
| ..., | | |
| [[ | | |
| reportQuantityUTRA-FDD-r16 | MeasReportQuantityUTRA-FDD-r16 | |
| OPTIONAL -- Need R | | |
| ]], | | |
| [[ | | |
| includeCommonLocationInfo-r16 | ENUMERATED {true} | |
| OPTIONAL, -- Need R | | |
| includeBT-Meas-r16 | SetupRelease (BT-NameList-r16) | |
| OPTIONAL, -- Need M | | |
| includeWLAN-Meas-r16 | SetupRelease {WLAN-NameList-r16} | |
| OPTIONAL, -- Need M | | |
| includeSensor-Meas-r16 | SetupRelease {Sensor-NameList-r16} | |
| OPTIONAL -- Need M | | |
| ]], | | |
| [[ | | |
| reportQuantityRelay-r17 | SL-MeasReportQuantity-r16 | |
| OPTIONAL -- Need R | | |
| ]] | | |
| } | | |
| MeasTriggerQuantityUTRA-FDD-r16 ::= | CHOICE{ | |
| utra-FDD-RSCP-r16 | INTEGER (−5..91), | |
| utra-FDD-EcN0-r16 | INTEGER (0..49) | |
| } | | |
| MeasReportQuantityUTRA-FDD-r16 ::= | SEQUENCE { | |
| cpich-RSCP | BOOLEAN, | |
| cpich-EcN0 | BOOLEAN | |
| } | | |

As an embodiment of the present disclosure, reportType may be configured to eventTriggered, and event configuration information (e.g., EventA3, EventA4, EventA5, EventB1, EventB2) may include numberOfTriggeringCells. numberOfTriggeringCells may indicate the number of cells detected that are required to fulfill an event for a measurement report to be triggered.

The entering or leaving conditions of the event may be as follows.

```
5.5.4.4Event A3 (Neighbour becomes offset better than SpCell)
The UE shall:
  1>consider the entering condition for this event to be satisfied when condition A3-1, as
    specified below, is fulfilled;
  1>consider the leaving condition for this event to be satisfied when condition A3-2, as
    specified below, is fulfilled;
  1>use the SpCell for Mp, Ofp and Ocp.
  NOTE 1:The cell(s) that triggers the event has reference signals indicated in the
        measObjectNR associated to this event which may be different from the NR SpCell
        measObjectNR.
Inequality A3-1 (Entering condition)
Mn + Ofn + Ocn - Hys > Mp + Ofp + Ocp + Off
Inequality A3-2 (Leaving condition)
Mn + Ofn + Ocn + Hys < Mp + Ofp + Ocp + Off
The variables in the formula are defined as follows:
  Mn is the measurement result of the neighbouring cell, not taking into account any offsets.
  Ofn is the measurement object specific offset of the reference signal of the neighbour cell
    (i.e. offsetMO as defined within measObjectNR corresponding to the neighbour cell).
  Ocn is the cell specific offset of the neighbour cell (i.e. cellIndividualOffset as defined within
    measObjectNR corresponding to the frequency of the neighbour cell), and set to zero if
    not configured for the neighbour cell.
  Mp is the measurement result of the SpCell, not taking into account any offsets.
  Ofp is the measurement object specific offset of the SpCell (i.e. offsetMO as defined within
    measObjectNR corresponding to the SpCell).
  Ocp is the cell specific offset of the SpCell (i.e. cellIndividualOffset as defined within
    measObjectNR corresponding to the SpCell), and is set to zero if not configured for the
    SpCell.
  Hys is the hysteresis parameter for this event (i.e. hysteresis as defined within
    reportConfigNR for this event).
  Off is the offset parameter for this event (i.e. a3-Offset as defined within reportConfigNR for
    this event).
  Mn, Mp are expressed in dBm in case of RSRP, or in dB in case of RSRQ and RS-SINR.
  Ofn, Ocn, Ofp, Ocp, Hys, Off are expressed in dB.
  NOTE 2: The definition of Event A3 also applies to CondEvent A3.
5.5.4.5Event A4 (Neighbour becomes better than threshold)
The UE shall:
  1>consider the entering condition for this event to be satisfied when condition A4-1, as
    specified below, is fulfilled;
  1>consider the leaving condition for this event to be satisfied when condition A4-2, as
    specified below, is fulfilled.
Inequality A4-1 (Entering condition)
Mn + Ofn + Ocn − Hys > Thresh
Inequality A4-2 (Leaving condition)
Mn + Ofn + Ocn + Hys < Thresh
The variables in the formula are defined as follows:
  Mn is the measurement result of the neighbouring cell, not taking into account any offsets.
  Of is the measurement object specific offset of the neighbour cell (i.e. offsetMO as defined
    within measObjectNR corresponding to the neighbour cell).
  Ocn is the measurement object specific offset of the neighbour cell (i.e. cellIndividualOffset
    as defined within measObjectNR corresponding to the neighbour cell), and set to zero if
    not configured for the neighbour cell.
  Hys is the hysteresis parameter for this event (i.e. hysteresis as defined within
    reportConfigNR for this event).
  Thresh is the threshold parameter for this event (i.e. a4-Threshold as defined within
    reportConfigNR for this event).
  Mn is expressed in dBm in case of RSRP, or in dB in case of RSRQ and RS-SINR.
  Ofn, Ocn, Hys are expressed in dB.
  Thresh is expressed in the same unit as Mn.
  NOTE: The definition of Event A4 also applies to CondEvent A4.
5.5.4.6Event A5 (SpCell becomes worse than threshold1 and neighbour becomes
          better than threshold2)
The UE shall:
  1>consider the entering condition for this event to be satisfied when both condition A5-1 and
    condition A5-2, as specified below, are fulfilled;
  1>consider the leaving condition for this event to be satisfied when condition A5-3 or
    condition A5-4, i.e. at least one of the two, as specified below, is fulfilled;
  1>use the SpCell for Mp.
  NOTE 1:The parameters of the reference signal(s) of the cell(s) that triggers the event are
          indicated in the measObjectNR associated to the event which may be different from
          the measObjectNR of the NR SpCell.
Inequality A5-1 (Entering condition 1)
Mp + Hys < Threshl
Inequality A5-2 (Entering condition 2)
Mn + Ofn + Ocn − Hys > Thresh2
Inequality A5-3 (Leaving condition 1)
Mp − Hys > Thresh1
Inequality A5-4 (Leaving condition 2)
Mn + Ofn + Ocn + Hys < Thresh2
The variables in the formula are defined as follows:
  Mp is the measurement result of the NR SpCell, not taking into account any offsets.
  Mn is the measurement result of the neighbouring cell, not taking into account any offsets.
  Ofn is the measurement object specific offset of the neighbour cell (i.e. offsetMO as defined
    within measObjectNR corresponding to the neighbour cell).
  Ocn is the cell specific offset of the neighbour cell (i.e. cellIndividualOfset as defined within
    measObjectNR corresponding to the neighbour cell), and set to zero if not configured for
    the neighbour cell.
  Hys is the bysteresis parameter for this event (i.e. hysteresis as defined within
    reportConfigNR for this event).
  Thresh1 is the threshold parameter for this event (i.e. a5-Threshold) as defined within
    reportConfigNR for this event).
  Thresh2 is the threshold parameter for this event (i.e. a5-Threshold2 as defined within
    reportConfigNR for this event).
  Mn, Mp are expressed in dBm in case of RSRP, or in dB in case of RSRQ and RS-SINR.
  Ofn, Ocn, Hys are expressed in dB.
  Thresht1is expressed in the same unit as Mp.
  Thresh2 is expressed in the same unit as Mn.
  NOTE 2:The definition of Event A5 also applies to CondEvent A5.
5.5.4.8Event B1 (Inter RAT neighbour becomes better than threshold)
The UE shall:
  1>consider the entering condition for this event to be satisfied when condition B1-1, as
    specified below, is fulfilled;
  1>consider the leaving condition for this event to be satisfied when condition B1-2, as
    specified below, is fulfilled.
Inequality B1-1 (Entering condition)
Mn + Ofn + Ocn − Hys > Thresh
Inequality B1-2 (Leaving condition)
Mn + Ofn + Ocn + Hys < Thresh
The variables in the formula are defined as follows:
  Mn is the measurement result of the inter-RAT neighbour cell, not taking into account any
    offsets.
  Ofn is the measurement object specific offset of the frequency of the inter-RAT neighbour
    cell (i.e. eutra-Q-OffsetRange as defined within the measObjectEUTRA corresponding to
    the frequency of the neighbour inter-RAT cell, utra-FDD-Q-OffsetRange as defined
    within the measObjectUTRA-FDD corresponding to the frequency of the neighbour inter-
    RAT cell).
  Ocn is the cell specific offset of the inter-RAT neighbour cell (i.e. cellIndividualOffset as
    defined within the measObjectEUTRA corresponding to the neighbour inter-RAT cell),
    and set to zero if not configured for the neighbour cell.
  Hys is the hysteresis parameter for this event (i.e. hysteresis as defined within
    reportConfiginterRAT for this event).
  Thresh is the threshold parameter for this event (i.e. b1-ThresholdEUTRA as defined within
    reportConfigInterRAT for this event, b1-ThresholdUTRA-FDD as defined for UTRA-
    FDD within reportConfigInterRAT for this event).
  Mn is expressed in dBm or in dB, depending on the measurement quantity of the inter-RAT
    neighbour cell.
  Ofn, Ocn, Hys are expressed in dB.
  Thresh is expressed in the same unit as Mn.
5.5.4.9Event B2 (PCell becomes worse than threshold1 and inter RAT neighbour
          becomes better than threshold2)
The UE shall:
  1>consider the entering condition for this event to be satisfied when both condition B2-1 and
    condition B2-2, as specified below, are fulfilled;
  1>consider the leaving condition for this event to be satisfied when condition B2-3 or
    condition B2-4, i.e. at least one of the two, as specified below, is fulfilled;
Inequality B2-1 (Entering condition 1)
Mp + Hys < Thresh1
Inequality B2-2 (Entering condition 2)
Mn + Ofn + Ocn − Hys > Thresh2
Inequality B2-3 (Leaving condition 1)
Mp − Hys > Thresh1
Inequality B2-4 (Leaving condition 2)
Mn + Ofn + Ocn + Hys < Thresh2
The variables in the formula are defined as follows:
  Mp is the measurement result of the PCell, not taking into account any offsets.
  Mn is the measurement result of the inter-RAT neighbour cell, not taking into account any
    offsets.
  Ofn is the measurement object specific offset of the frequency of the inter-RAT neighbour
    cell (i.e. eutra-Q-OffsetRange as defined within the measObjectEUTRA corresponding to
    the frequency of the inter-RAT neighbour cell, utra-FDD-Q-OffsetRange as defined
    within the measObjectUTRA-FDD corresponding to the frequency of the neighbour inter-
    RAT cell).
  Ocn is the cell specific offset of the inter-RAT neighbour cell (i.e. cellIndividualOffset as
    defined within the measObjectEUTRA corresponding to the neighbour inter-RAT cell).
    and set to zero if not configured for the neighbour cell.
  Hys is the hysteresis parameter for this event (i.e. hysteresis as defined within
    reportConfigInterRAT for this event).
  Thresh1 is the threshold parameter for this event (i.e. b2-Threshold) as defined within
    reportConfigInterRAT for this event).
  Thresh2 is the threshold parameter for this event (i.e. b2-Threshold2EUTRA as defined
    within reportConfigInterRAT for this event, b2-Threshold2UTRA-FDD as defined for
    UTRA-FDD within reportConfigInterRAT for this event).
  Mp is expressed in dBm in case of RSRP, or in dB in case of RSRQ and SINR.
  Mn is expressed in dBm or dB, depending on the measurement quantity of the inter-RAT
    neighbour cell.
  Ofn, Ocn, Hys are expressed in dB.
  Thresh1 is expressed in the same unit as Mp.
  Thresh2 is expressed in the same unit as Mn.
```

In step 530, the UE may determine whether to transmit the measurement report based on the measurement configuration information received in step 525. Specifically, the UE may initiate a measurement reporting procedure when at least one of the following conditions is fulfilled.

```
2>if the triggerType is set to event and if the corresponding reportConfig includes
  numberOfTriggeringCells, and if the entry condition applicable for this event, i.e. the
  event corresponding with the eventId of the corresponding reportConfig within
  VarMeasConfig, is fulfilled for one or more applicable cells for all measurements after
  layer 3 filtering taken during timeToTrigger defined for this event within the
  VarMeasConfig:
  3>If the VarMeasReportList does not include a measurement reporting entry for this
    measId (a first cell triggers the event):
    4>include a measurement reporting entry within the VarMeasReportList for this
      measId:
  3>If the number of cell(s) in the cellsTriggeredList is larger than or equal to
    numberOfTriggeringCells:
    4>include the concerned cell(s) in the cellsTriggeredList defined within the
      VarMeasReportList for this measId;
  3>else:
    4>include the concerned cell(s) in the cellsTriggeredList defined within the
      VarMeasReportList for this measId;
    4>If the number of cell(s) in the cellsTriggeredList is larger than or equal to
      numberOfTriggeringCells:
      5>set the numberOfReportsSent defined within the VarMeasReportList for this
        measId to 0;
      5>initiate the measurement reporting procedure, as specified in 5.5.5;
2>if the triggerType is set to event and if the leaving condition applicable for this event is
  fulfilled for one or more of the cells included in the cellsTriggeredList defined within
  the VarMeasReportList for this measId for all measurements after layer 3 filtering taken
  during timeToTrigger defined within the VarMeasConfig for this event:
3>remove the concerned cell(s) in the cellsTriggeredList defined within the
  varMeasReportList for this measId;
3>if reportOnLeave is set to TRUE for the corresponding reporting configuration or if
  a6-ReportOnLeave is set to TRUE or if a4-a5-ReportOnLeave is set to TRUE for
  the corresponding reporting configuration:
  4>initiate the measurement reporting procedure, as specified in 5.5.5;
3>if the cellsTriggeredList defined within the VarMeasReportList for this measId is
  empty:
  4>remove the measurement reporting entry within the VarMeasReportList for this
    measId:
  4>stop the periodical reporting timer for this measId, if running;
```

When the UE initiates the measurement reporting procedure in step 530, the UE may transmit a measurement report to the base station in step 535. The procedure for the UE to transmit the measurement report to the base station may be as follows.

```
For the measId for which the measurement reporting procedure was triggered, the UE shall set
the measResults within the MeasurementReport message as follows:
  1>set the measId to the measurement identity that triggered the measurement reporting;
  1>for each serving cell configured with servingCellMO:
    2>if the reportConfig associated with the measId that triggered the measurement reporting
      includes rsType:
      3>if the serving cell measurements based on the rsType included in the reportConfig
        that triggered the measurement report are available:
        4>set the measResultServingCell within measResultServingMOList to include
          RSRP, RSRQ and the available SINR of the serving cell, derived based on the
          rsType included in the reportConfig that triggered the measurement report;
    2>else:
      3>if SSB based serving cell measurements are available:
        4>set the measResultServingCell within measResultServingMOList to include
          RSRP, RSRQ and the available SINR of the serving cell, derived based on SSB;
      3>else if CSI-RS based serving cell measurements are available:
        4>set the measResultServingCell within measResultServingMOList to include
          RSRP, RSRQ and the available SINR of the serving cell, derived based on CSI-
          RS;
  1>set the servCellId within measResultServingMOList to include each NR serving cell that
    is configured with servingCellMO, if any;
  1>if the reportConfig associated with the measId that triggered the measurement reporting
    includes reportQuantityRS-Indexes and maxNrofRS-IndexesToReport:
    2>for each serving cell configured with servingCellMO, include beam measurement
      information according to the associated reportConfig as described in 5.5.5.2;
  1>if the reportConfig associated with the measId that triggered the measurement reporting
    includes reportAddNeighMeas:
  2>for each measObjectId referenced in the measIdList which is also referenced with
    servingCellMO, other than the measObjectId corresponding with the measId that
    triggered the measurement reporting:
    3>if the measObjectNR indicated by the servingCellMO includes the RS resource
      configuration corresponding to the rsType indicated in the reportConfig:
      4>set the measResultBestNeighCell within measResultServingMOList to include the
        physCellId and the available measurement quantities based on the
        reportQuantityCell and rsType indicated in reportConfig of the non-serving cell
        corresponding to the concerned measObjectNR with the highest measured RSRP
        if RSRP measurement results are available for cells corresponding to this
        measObjectNR, otherwise with the highest measured RSRQ if RSRQ
        measurement results are available for cells corresponding to this measObjectNR.
        otherwise with the highest measured SINR;
      4>if the reportConfig associated with the measId that triggered the measurement
        reporting includes reportQuantityRS-Indexes and maxNrofRS-IndexesToReport:
        5>for each best non-serving cell included in the measurement report:
          6>include beam measurement information according to the associated
            reportConfig as described in 5.5.5.2;
  1>if the reportConfig associated with the measId that triggered the measurement reporting is
    set to eventTriggered and eventID is set to eventA3, or eventA4, or eventA5, or eventB1,
    or eventB2:
    2>if the UE is in NE-DC and the measurement configuration that triggered this
      measurement report is associated with the MCG:
      3>set the measResultServFreqListEUTRA-SCG to include an entry for each E-UTRA
        SCG serving frequency with the following:
        4>include carrierFreq of the E-UTRA serving frequency;
        4>set the measResultServingCell to include the available measurement quantities
          that the UE is configured to measure by the measurement configuration
          associated with the SCG;
        4>if reportConfig associated with the measId that triggered the measurement
          reporting includes reportAddNeighMeas:
          5>set the measResultServFreqListEUTRA-SCG to include within
            measResultBestNeighCell the quantities of the best non-serving cell, based on
            RSRP, on the concerned serving frequency;
  1>if reportConfig associated with the measId that triggered the measurement reporting is set
    to eventTriggered and eventID is set to eventA3, or eventA4, or eventA5:
    2>if the UE is in NR-DC and the measurement configuration that triggered this
      measurement report is associated with the MCG:
      3>set the measResultServFreqListNR-SCG to include for each NR SCG serving cell
        that is configured with servingCellMO, if any, the following:
        4>if the reportConfig associated with the measId that triggered the measurement
          reporting includes rsType:
          5>if the serving cell measurements based on the rsType included in the
            reportConfig that triggered the measurement report are available according to
            the measurement configuration associated with the SCG:
            6>set the measResultServingCell within measResultServFreqListNR-SCG to
              include RSRP, RSRQ and the available SINR of the serving cell, derived
              based on the rsType included in the reportConfig that triggered the
              measurement report:
        4>else:
          5>if SSB based serving cell measurements are available according to the
            measurement configuration associated with the SCG:
            6>set the measResultServingCell within measResultServFreqListNR-SCG to
              include RSRP, RSRQ and the available SINR of the serving cell, derived
              based on SSB;
          5>else if CSI-RS based serving cell measurements are available according to the
            measurement configuration associated with the SCG:
            6>set the measResultServingCell within measResultServFreqListNR-SCG to
              include RSRP, RSRQ and the available SINR of the serving cell, derived
              based on CSI-RS;
        4>if results for the serving cell derived based on SSB are included:
          5>include the ssbFrequency to the value indicated by ssbFrequency as included
            in the MeasObjectNR of the serving cell;
        4>if results for the serving cell derived based on CSI-RS are included:
          5>include the refFreqCSI-RS to the value indicated by refFreqCSI-RS as
            included in the MeasObjectNR of the serving cell;
        4>if the reportConfig associated with the measId that triggered the measurement
          reporting includes reportQuantityRS-Indexes and maxNrofRS-IndexesToReport:
          5>for each serving cell configured with servingCellMO, include beam
            measurement information according to the associated reportConfig as
            described in 5.5.5.2, where availability is considered according to the
            measurement configuration associated with the SCG;
        4>if reportConfig associated with the measId that triggered the measurement
          reporting includes reportAddNeighMeas:
          5>if the measObjectNR indicated by the servingCellMO includes the RS resource
            configuration corresponding to the rsType indicated in the reportConfig:
            6>set the measResultBestNeighCellListNR within
              measResultServFreqListNR-SCG to include one entry with the physCellId
              and the available measurement quantities based on the reportQuantityCell
              and rsType indicated in reportConfig of the non-serving cell corresponding
              to the concerned measObjectNR with the highest measured RSRP if RSRP
              measurement results are available for cells corresponding to this
              measObjectNR, otherwise with the highest measured RSRQ if RSRQ
              measurement results are available for cells corresponding to this
              measObjectNR, otherwise with the highest measured SINR, where
              availability is considered according to the measurement configuration
              associated with the SCG;
              7>if the reportConfig associated with the measId that triggered the
                measurement reporting includes reportQuantityRS-Indexes and
                maxNrofRS-IndexesToReport:
                8>for each best non-serving cell included in the measurement report:
                  9>include beam measurement information according to the
                    associated reportConfig as described in 5.5.5.2, where availability
                    is considered according to the measurement configuration
                    associated with the SCG;
  1>if the measRSSI-ReportConfig is configured within the corresponding reportConfig for
    this measId:
    2>set the rssi-Result to the linear average of sample value(s) provided by lower layers in
      reportInterval;
    2>set the channelOccupancy to the rounded percentage of sample values which are
      beyond the channelOccupancyThreshold within all the sample values in the
      reportInterval;
  1>if the UE is acting as L2 U2N Remote UE:
    2>set the sl-MeasResultServingRelay in accordance with the following:
      3>set the cellIdentity to include the cellAccessRelatedInfo contained in the discovery
        message received from the serving L2 U2N Relay UE;
      3>set the sl-RelayUE-Identity to include the Source L2 ID of the serving L2 U2N
        Relay;
      3>set the sl-MeasResult to include the SL-RSRP of the serving L2 U2N Relay UE;
  NOTE 1:In case of no data transmission from L2 U2N Relay UE to L2 U2N Remote UE, it
        is left to UE implementation whether to use SL-RSRP or SD-RSRP when setting
        the sl-MeasResultServingRelay of the serving L2 U2N Relay UE.
  1>if there is at least one applicable neighbouring cell or candidate L2 U2N Relay UE to
    report;
    2>if the reportType is set to eventTriggered or periodical:
      3>if the measurement report concerns the candidate L2 U2N Relay UE:
        4>set the sl-MeasResultsCandRelay in measResultNeighCells to include the best
          candidate L2 U2N Relay UEs up to maxReportCells in accordance with the
          following:
          5>if the reportType is set to eventTriggered:
            6>include the L2 U2N Relay UEs included in the relaysTriggeredList as
              defined within the VarMeasReportList for this measId;
          5>else:
            6>include the applicable L2 U2N Relay UEs for which the new measurement
              results became available since the last periodical reporting or since the
              measurement was initiated or reset;
          5>for each L2 U2N Relay UE that is included in the sl-MeasResultsCandRelay;
            6>set the cellIdentity to include the cellAccessRelatedInfo contained in the
              discovery message received from the concerned L2 U2N Relay UE:
            6>set the si-RelayUE-Identity to include the Source L2 ID of the concerned
              L2 U2N Relay UE;
            6>set the sl-MeasResult to include the SD-RSRP of the concerned L2 U2N
              Relay UE;
          5>for each included L2 U2N Relay UE, include the layer 3 filtered measured
            results in accordance with the reportConfig for this measId, ordered as
            follows:
            6>set the sl-MeasResult to include the quantity(ies) indicated in the
              reportQuantityRelay within the concerned reportConfigRelay in
              decreasing order of the sorting quantity, determined as specified in 5.5.5.3,
              i.e. the best L2 U2N Relay UE is included first;
      3>else:
        4>set the measResultNeighCells to include the best neighbouring cells up to
          maxReportCells in accordance with the following:
          5>if the reportType is set to eventTriggered and eventId is not set to eventD1;
            6>include the cells included in the cellsTriggeredList as defined within the
              VarMeasReportList for this measId:
          5>else:
            6>include the applicable cells for which the new measurement results became
              available since the last periodical reporting or since the measurement was
              initiated or reset;
          5>for each cell that is included in the measResultNeighCells, include the
            physCellId;
          5>if the reportType is set to eventTriggered or periodical:
            6>for each included cell, include the layer 3 filtered measured results in
              accordance with the reportConfig for this measId, ordered as follows:
              7>if the measObject associated with this measId concerns NR:
                8>if rsType in the associated reportConfig is set to ssb:
                  9>set resultsSSB-Cell within the measResult to include the SS/PBCH
                    block based quantity(ies) indicated in the reportQuantityCell
                    within the concerned reportConfig, in decreasing order of the
                    sorting quantity, determined as specified in 5.5.5.3. i.e. the best
                    cell is included first;
                  9>if reportQuantityRS-Indexes and maxNrofRS-IndexesToReport are
                    configured, include beam measurement information as described
                    in 5.5.5.2;
                8>else if rsType in the associated reportConfig is set to csi-rs:
                  9>set resultsCSI-RS-Cell within the measResult to include the CSI-
                    RS based quantity(ies) indicated in the reportQuantityCell within
                    the concerned reportConfig, in decreasing order of the sorting
                    quantity, determined as specified in 5.5.5.3, i.e. the best cell is
                    included first;
                  9>if reportQuantityRS-Indexes and maxNrofRS-IndexesToReport are
                    configured, include beam measurement information as described
                    in 5.5.5.2;
              7>if the measObject associated with this measId concerns E-UTRA:
                8>set the measResult to include the quantity(les) indicated in the
                  reportQuantity within the concerned reportConfigInterRAT in
                  decreasing order of the sorting quantity, determined as specified in
                  5.5.5.3, i.e. the best cell is included first;
              7>if the measObject associated with this measId concerns UTRA-FDD and
                if ReportConfigInterRAT includes the reportQuantityUTRA-FDD:
                8>set the measResult to include the quantity(les) indicated in the
                  reportQuantity UTRA-FDD within the concerned
                  reportConfiginterRAT in decreasing order of the sorting quantity,
                  determined as specified in 5.5.5.3, i.e. the best cell is included first;
    2>else:
      3>if the cell indicated by cellForWhichToReportCGI is an NR cell:
        4>if plmn-IdentityInfoList of the cgi-Info for the concerned cell has been obtained:
          5>include the plmn-IdentityInfoList including plmn-IdentityList,
            trackingAreaCode (if available), trackingAreaList (if available), ranac (if
            available), cellIdentity and cellReservedForOperatorUse for each entry of the
            plmn-IdentityInfoList:
          5>include frequencyBandList if available;
          5>for each PLMN-IdentityInfo in plmn-IdentityInfoList:
            6>if the gNB-ID-Length is broadcast:
              7>include gNB-ID-Length;
        4>if nr-CGI-Reporting-NPN is supported by the UE and npn-IdentityInfoList of the
          cgi-Info for the concerned cell has been obtained:
          5>include the npn-IdentityInfoList including non-IdentityList,
            trackingAreaCode. ranac (if available), cellIdentity and
            cellReservedForOperatorUse for each entry of the npn-IdentityInfoList;
          5>for each NPN-IdentityInfo in NPN-IdentityInfoList.
            6>if the gNB-ID-Length is broadcast:
              7>include gNB-ID-Length:
          5>include cellReservedForOtherUse if available;
        4>else if MIB indicates the SIB1 is not broadcast:
          5:>include the noSIB1 including the ssb-SubcarrierOffset and pdcch-ConfigSIB1
            obtained from MIB of the concerned cell;
      3>if the cell indicated by cellForWhichToReportCG1 is an E-UTRA cell:
        4>if all mandatory fields of the cgi-Info-EPC for the concerned cell have been
          obtained:
          5>include in the cgi-Info-EPC the fields broadcasted in E-UTRA
            SystemInformationBlockType1 associated to EPC;
        4>if the UE is E-UTRA/5GC capable and all mandatory fields of the cgi-Info-5GC
          for the concerned cell have been obtained:
          5>include in the cgi-Info-5GC the fields broadcasted in E-UTRA
            SystemInformationBlockType1 associated to 5GC:
        4>if the mandatory present fields of the cgi-Info for the cell indicated by the
          cellForWhichToReportCGI in the associated measObject have been obtained:
          5>include the freqBandIndicator;
          5>if the cell broadcasts the multiBandInfoList, include the multiBandInfoList:
          5>if the cell broadcasts the freqBandIndicatorPriority, include the
            freqBandIndicatorPriority;
  1>if the corresponding measObject concerns NR:
    2>if the reportSFTD-Meas is set to true within the corresponding reportConfigNR for this
      measId:
      3>set the measResultSFTD-NR in accordance with the following:
        4>set sfn-OffsetResult and frameBoundaryOffsetResult to the measurement results
          provided by lower layers;
        4>if the reportRSRP is set to true;
          5>set rsrp-Result to the RSRP of the NR PSCell derived based on SSB;
    2>else if the reportSFTD-NeighMeas is included within the corresponding
      reportConfigNR for this measId:
      3>for each applicable cell which measurement results are available, include an entry in
        the measResultCellListSFTD-NR and set the contents as follows:
        4>set physCellId to the physical cell identity of the concerned NR neighbour cell.
        4>set sfn-OffsetResult and frameBoundaryOffsetResult to the measurement results
          provided by lower layers;
        4>if the reportRSRP is set to true:
          5>set rsrp-Result to the RSRP of the concerned cell derived based on SSB;
  1>else if the corresponding measObject concerns E-UTRA:
    2>if the reportSFTD-Meas is set to true within the corresponding reportConfiginterRAT
      for this measId:
      3>set the measResultSFTD-EUTRA in accordance with the following:
        4>set sfh-OffsetResult and frameBoundaryOffsetResult to the measurement results
          provided by lower layers;
        4>if the reportRSRP is set to true;
          5>set rsrpResult-EUTRA to the RSRP of the EUTRA PSCell;
  1>if average uplink PDCP delay values are available:
    2>set the ul-PDCP-DelayValueResultList to include the corresponding average uplink
      PDCP delay values;
  1>if PDCP excess delay measurements are available:
    2>set the ul-PDCP-ExcessDelayResultList to include the corresponding PDCP excess
      delay measurements;
  1>if the includeCommonLocationInfo is configured in the corresponding reportConfig for
    this measId and detailed location information that has not been reported is available, set
    the content of commonLocationinfo of the locationInfo as follows:
    2>include the locationTimestamp;
    2>include the locationCoordinate, if available;
    2>include the velocityEstimate, if available;
    2>include the locationError, if available;
    2>include the locationSource, if available;
    2>if available, include the gnss-TOD-msec,
  1>if the coarseLocationRequest is set to true in the corresponding reportConfig for this
    measId:
    2>include coarseLocationinfo, if available;
  1>if the includeWLAN-Meas is configured in the corresponding reportConfig for this measId,
    set the wlan-LocationInfo of the locationInfo in the measResults as follows:
    2>if available, include the LogMeasResultWLAN, in order of decreasing RSSI for WLAN
      APS;
  1>if the includeBT-Meas is configured in the corresponding reportConfig for this measId, set
the BT-LocationInfo of the locationInfo in the measResults as follows:
    2>if available, include the LogMeasResultBT, in order of decreasing RSSI for Bluetooth
    beacons:
  1>if the includeSensor-Meas is configured in the corresponding reportConfig for this measId,
    set the sensor-LocationInfo of the locationInfo in the measResults as follows:
    2>if available, include the sensor-MeasurementInformation;
    2>if available, include the sensor-MotionInformation;
  1>if there is at least one applicable transmission resource pool for NR sidelink
    communication/discovery (for measResultsSL):
    2>set the measResultsListSL to include the CBR measurement results in accordance with
      the following:
      3>if the reportType is set to eventTriggered:
        4>include the transmission resource pools included in the poolsTriggeredList as
          defined within the VarMeasReportList for this measId;
      3>else:
        4>include the applicable transmission resource pools for which the new
          measurement results became available since the last periodical reporting or since
          the measurement was initiated or reset;
      3>if the corresponding measObject concerns NR sidelink communication/discovery,
        then for each transmission resource pool to be reported:
        4>set the sl-poolReportIdentity to the identity of this transmission resource pool;
        4>set the si-CBR-ResultsNR to the CBR measurement results on PSSCH and
          PSCCH of this transmission resource pool provided by lower layers, if available;
  NOTE 1:Void.
  1>if there is at least one applicable CLI measurement resource to report:
    2>if the reportType is set to cli-EventTriggered or cli-Periodical:
      3>set the measResultCLI to include the most interfering SRS resources or most
        interfering CLI-RSSI resources up to maxReportCLI in accordance with the
        following:
        4>if the reportType is set to cli-EventTriggered:
          5>if trigger quantity is set to srs-RSRP i.e. il-Threshold is set to srs-RSRP:
            6>include the SRS resource included in the cli-TriggeredList as defined within
              the VarMeasReportList for this measId;
          5>if trigger quantity is set to cli-RSSI i.e. il-Threshold is set to cli-RSSI:
            6>include the CLI-RSSI resource included in the cli-TriggeredList as defined
              within the VarMeasReportList for this measId:
        4>else:
          5>if reportQuantityCLI is set to srs-rsrp:
            6>include the applicable SRS resources for which the new measurement
              results became available since the last periodical reporting or since the
              measurement was initiated or reset;
          5>else;
            6>include the applicable CLI-RSSI resources for which the new measurement
              results became available since the last periodical reporting or since the
              measurement was initiated or reset;
        4>for each SRS resource that is included in the measResultCLI:
          5>include the srs-ResourceId;
          5>set srs-RSRP-Result to include the layer 3 filtered measured results in
            decreasing order, i.e. the most interfering SRS resource is included first;
        4>for each CLI-RSSI resource that is included in the measResultCLI.
          5>include the rssi-ResourceId;
          5>set cli-RSSI-Result to include the layer 3 filtered measured results in
            decreasing order, i.e. the most Interfering CLI-RSSI resource is included first;
  1>if there is at least one applicable UE Rx-Tx time difference measurement to report:
    2>set measResultRxTxTimeDiff to the latest measurement result;
  1>increment the numberOfReportsSent as defined within the VarMeasReportList for this
    measId by 1;
  1>stop the periodical reporting timer, if running;
  1>if the numberOfReportsSent as defined within the VarMeasReportList for this measId is
    less than the reportAmount as defined within the corresponding reportConfig for this
    measId:
    2>start the periodical reporting timer with the value of reportinterval as defined within
      the corresponding reportConfig for this measId;
  1>else:
    2>if the reportType is set to periodical or cli-Periodical or rxTxPeriodical:
      3>remove the entry within the VarMeasReportList for this measId;
      3>remove this measId from the measIdList within VarMeasConfig;
  1>if the measurement reporting was configured by a sl-ConfigDedicatedNR received within
    the RRCConnectionReconfiguration:
    2>submit the MeasurementReport message to lower layers for transmission via SRB1,
      embedded in E-UTRA RRC message ULInformationTransferIRAT as specified TS
      36.331 [10], clause 5.6.28;
  1>else if the UE is in (NG)EN-DC:
    2>if SRB3 is configured and the SCG is not deactivated:
      3>submit the MeasurementReport message via SRB3 to lower layers for transmission,
        upon which the procedure ends;
    2>else:
      3>submit the MeasurementReport message via E-UTRA embedded in E-UTRA RRC
        message ULInformationTransfer MRDC as specified in TS 36.331 [10].
  1>else if the UE is in NR-DC:
    2>if the measurement configuration that triggered this measurement report is associated
      with the SCG:
      3>if SRB3 is configured and the SCG is not deactivated:
        4>submit the MeasurementReport message via SRB3 to lower layers for
          transmission, upon which the procedure ends;
      3>else:
        4>submit the MeasurementReport message via SRB1 embedded in NR RRC
          message ULInformationTransferMRDC as specified in 5.7.2a.3;
    2>else:
      3>submit the MeasurementReport message via SRB1 to lower layers for transmission,
        upon which the procedure ends;
  1>else:
    2>submit the MeasurementReport message to lower layers for transmission, upon which
      the procedure ends.
```

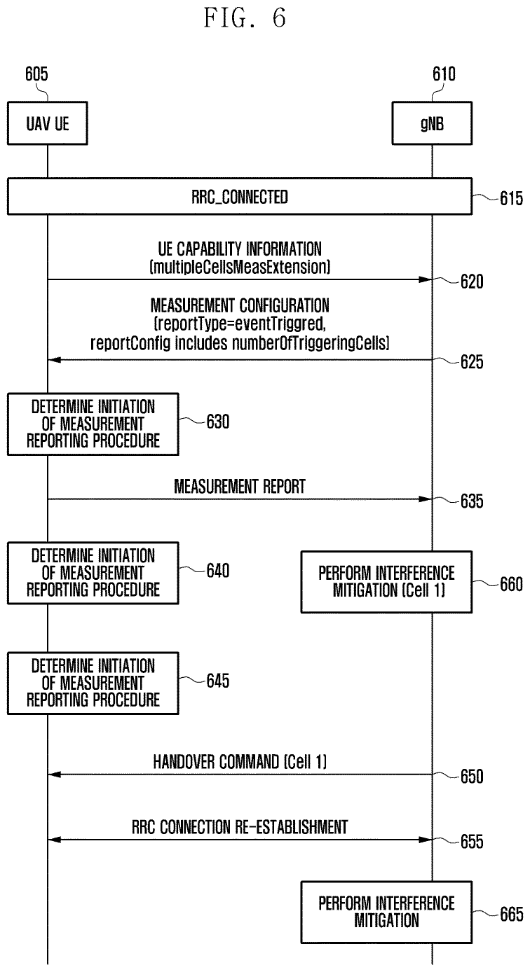

FIG. 6 is a diagram illustrating an example in which the efficiency of handover or interference mitigation is reduced when the UAV UE transmits the measurement report to the base station in the next-generation mobile communication system according to an embodiment of the present disclosure.

Referring to FIG. 6, a UAV UE 605 may establish an RRC connection with an NR base station 610 and thus may be in an RRC connected mode (RRC_CONNECTED) 615.

In step 620, the UE may transmit the UE capability information (UECapabilityInformation) message to the base station. The transmission of the UE capability information (UECapabilityInformation) message may follow the above-described embodiment (e.g., FIG. 5).

In step 625, the base station may transmit an RRC message (e.g., RRCResume or RRCReconfiguration) including measurement configuration information (MeasConfig) to the UE. The transmission of the RRC message (e.g., RRCResume or RRCReconfiguration) may follow the above-described embodiment (e.g., FIG. 5). For convenience of description, it is assumed that the base station configures numberOffriggeringCells to 3 and eventTriggered to EventA3 (of course, the eventTriggered may be configured to one of EventA4, EventA5, EventB1 EventB2 other than EventA3 or may be configured to another Event to which the numberOfriggeringCelts is applied).

In step 630, the UE may determine whether to initiate the measurement reporting procedure based on the measurement object information and the measurement configuration information received in step 625. Specifically, the UE may initiate the measurement reporting procedure when at least one of the following conditions is fulfilled.

```
2> if the triggerType is set to event and if the corresponding reportConfig includes
    numberOfTriggeringCells, and if the entry condition applicable for this event, i.e. the
    event corresponding with the eventId of the corresponding reportConfig within
    VarMeasConfig, is fulfilled for one or more applicable cells for all measurements after
    layer 3 filtering taken during timeToTrigger defined for this event within the
    VarMeasConfig:
    3> If the VarMeasReportList does not include a measurement reporting entry for this
      measId (a first cell triggers the event):
        4> include a measurement reporting entry within the VarMeasReportList for this
        measId;
    3> If the number of cell(s) in the cellsTriggeredList is larger than or equal to
      numberOfTriggeringCells:
      4> include the concerned cell(s) in the cellsTriggeredList defined within the
          VarMeasReportList for this measId;
    3> else:
        4> include the concerned cell(s) in the cellsTriggeredList defined within the
          VarMeasReportList for this measId;
        4> If the number of cell(s) in the cellsTriggeredList is larger than or equal to
          numberOfTriggeringCells:
          5> set the numberOfReportsSent defined within the VarMeasReportList for this
              measId to 0;
          5> initiate the measurement reporting procedure, as specified in 5.5.5;
```

In an embodiment, when the entry condition of EventA3 for Cell 1, Cell 2, and Cell 3 is fulfilled, the UE may include Cell 1, Cell 2, and Cell 3 in the cellsTriggeredList. The UE may initiate the measurement reporting procedure since the number of cells included in the cellsTriggeredList is larger than or equal to numberOfTriggeringCells.

In step 635, the UE may transmit the measurement report to the base station according to the above-described embodiment (e.g., FIG. 5).

Alternatively, in step 640, the UE may determine whether to initiate the measurement reporting procedure based on the measurement object information and the measurement configuration information received in step 625. For example, when the entry condition of EventA3 for Cell 1, Cell 2, Cell 3, and Cell 4 is fulfilled, the UE may include Cell 1, Cell 2, Cell 3, and Cell 4 in cellsTriggeredList. However, the UE may not initiate the measurement reporting procedure. For example, the UE has a feature that does not initiate the measurement reporting procedure when the following conditions are fulfilled. When the following conditions are fulfilled and the measurement reporting procedure is not initiated, step 635 may not be performed.

Once such condition is met and a measurement
report is sent, the list of triggered cells is updated
when subsequent cell(s) fulfil the event, however
further measurement reports are not sent while
the list of triggered cells remains larger than or
equal to the configured number of cells

Alternatively, in step 645, the UE may determine whether to initiate the measurement reporting procedure based on the measurement object information and the measurement configuration information received in step 625. For example, when the entry condition of EventA3 for Cell 2, Cell 3, and Cell 4 is fulfilled, the UE may include Cell 2, Cell 3, and Cell 4 in the cellsTriggeredList. However, the UE may not initiate the measurement reporting procedure. For example, Cell 1 may be released from the cellsTriggeredList since the following leaving conditions of EventA3 are fulfilled. In this case, when the reportOnLeave is not configured to TRUE, the UE may not initiate the measurement reporting procedure. When the measurement reporting procedure is not initiated, step 635 may not be performed.

```
2> if the reportType is set to eventTriggered and if the leaving condition applicable for
  this event is fulfilled for one or more of the cells included in the cellsTriggeredList
  defined within the VarMeasReportList for this measId for all measurements after layer
  3 filtering taken during timeToTrigger defined within the VarMeasConfig for this
  event:
  3> remove the concerned cell(s) in the cellsTriggeredList defined within the
      VarMeasReportList for this measId;
  3> if reportOnLeave is set to true for the corresponding reporting configuration:
      4> initiate the measurement reporting procedure, as specified in 5.5.5;
  3> if the cellsTriggeredList defined within the VarMeasReportList for this measId is
      empty:
      4> remove the measurement reporting entry within the VarMeasReportList for this
        measId;
      4> stop the periodical reporting timer for this measId, if running;
```

In step 650, the base station may transmit an RRC message (RRCReconfiguration) to the UE to instruct the handover to Cell 1. In step 655, the UE may perform an RRC connection re-establishment procedure with the base station since the handover to Cell 1 fails. The reasons why the UE fails the handover to Cell 1 may be as follows.

The UE transmitted the measurement report to the base station including Cell 1 that fulfills the EventA3 in step 635. However, even if Cell 1 no longer fulfils EventA3, the UE may have subsequently failed to notify the base station of the fact that Cell 1 no longer fulfills EventA3 through the measurement reporting procedure.

In step 660, the base station may request or instruct Cell 1 or another base station including Cell 1 to mitigate the interference. For example, the interference mitigation may be performed through at least one of beam control for downlink interference mitigation, multi transmission reception point (mTRP), or uplink transmission power control of the UE for uplink interference mitigation. The base station may perform different interference mitigation policies by considering interference levels of other Cells 2 and 3 included in the measurement report including an interference level of Cell 1.

In step 665, the interference mitigation operation for Cell 1 may no longer be helpful to the UE. In step 635, the UE transmitted the measurement report to the base station including Cell 1 that fulfils the EventA3. However, even if Cell 1 no longer fulfills EventA3, the UE may have failed to notify the base station of the fact that Cell 1 no longer fulfills EventA3 through the measurement reporting procedure. Such unnecessary interference mitigation operation may degrade the performance of the Cell 1 or the UE.

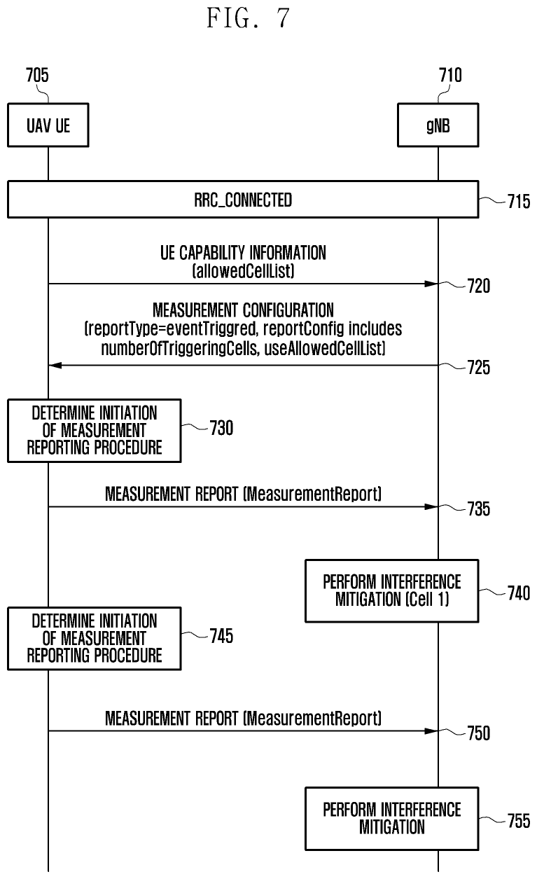

FIG. 7 is a diagram illustrating a process for the UAV UE to transmit a measurement report for a specific cell to the base station in the next-generation mobile communication system according to an embodiment of the present disclosure.

Referring to FIG. 7, a UAV UE 705 may establish an RRC connection with an NR base station 710 and thus may be in an RRC connected mode (RRC_CONNECTED) 715.

In step 720, the UE may transmit the UE capability information (UECapabilityInformation) message to the base station. The UE capability information message may include whether to support (e.g., allowedCellList) the allowedCellsToAddModList, which may be included in the measurement object configuration, and useAllowedCellList, which may be included in the measurement reporting configuration. The allowedCellList may indicate whether the capability is supported to use only the cell llist (allowedCellList) configured by the base station as a target for determining the event entering and leaving condition. That is, when the allowedCellList is included in the UE capability information or the allowedCellList is configured to True, it may indicate that the UE supports determining the event entering and leaving condition only for the list of cells (allowedCellsToAddModList) configured by the base station.

In step 725, the base station may transmit an RRC message (e.g., RRCResume or RRCReconfiguration) including measurement configuration information (MeasConfig) to the UE. The transmission of the RRC message (e.g., RRCResume or RRCReconfiguration) may follow the above-described embodiment (e.g., FIGS. 5 and 6). For convenience of description, it is assumed that the base station configures numberOfTriggeringCells to 3 and eventTriggered to EventA3 (of course, the eventTriggered may be configured to one of EventA4, EventA5, EventB1, EventB2 other than EventA3, or may be configured to another Event to which the numberOfTriggeringCells is applied). In addition, it is assumed that the measurement configuration information using the allowedCellList for receiving the measurement report for Cell 1 is configured. That is, it is assumed that the base station configures the first measurement configuration information in which numberOfTriggeringCells is configured to 3 and eventTriggered is configured to eventA3, and configures the second measurement configuration information in which Cell 1 includes in the allowedCellList, useAllowedCellList is configured to TRUE, and eventTriggered is configured to eventA3.

In step 730, the UE may determine whether to initiate the measurement reporting procedure based on the measurement object information and the measurement configuration information received in step 725. Specifically, the UE may determine the measurement object when at least one of the following conditions is fulfilled.

```
4> for measurement events other than eventAl, eventA2, eventD1 or eventX2:
    5> if useAllowedCellList is set to true:
      6> consider any neighbouring cell detected based on parameters in the
        associated measObjectNR to be applicable when the concerned cell is
        included in the allowedCellsToAddModList defined within the
        VarMeasConfig for this measId;
    5> else:
      6> consider any neighbouring cell detected based on parameters in the
        associated measObjectNR to be applicable when the concerned cell is not
        included in the excludedCellsToAddModList defined within the
        VarMeasConfig for this measId;
```

When the entry condition for Cell 1 is fulfilled, the UE may include Cell 1 in the cellsTriggeredList.

In step 735, the UE may transmit the measurement report to the base station according to the above-described embodiment (e.g., FIG. 5).

In step 740, the base station may request or instruct Cell 1 or another base station including Cell 1 to mitigate the interference. The request or instruction for the interference mitigation may follow the above-described embodiment (e.g., FIG. 6). In this case, the base station may not know whether there are other neighboring cells other than Cell 1 in the cell list of the UE, so the efficiency of the interference mitigation operation may be reduced.

In step 745, the UE may determine whether to initiate the measurement reporting procedure based on the measurement object information and the measurement configuration information received in step 725. That is, when the entry condition of EventA3 for Cell 1, Cell 2, and Cell 3 is fulfilled, the UE may include Cell 1, Cell 2, and Cell 3 in the cellsTriggeredList.

In step 750, the UE may transmit the measurement report to the base station according to the above-described embodiments (e.g., FIGS. 5 and 6).

In step 755, the base station may request or instruct Cell 1 or another base station including Cell 1 to mitigate the interference. The request or instruction for the interference mitigation may follow the above-described embodiment (e.g., FIG. 6). In this case, the base station may identify whether there are other neighboring cells (Cell 2, Cell 3) in the cell list of the UE, and the more efficient interference mitigation operation may be possible.

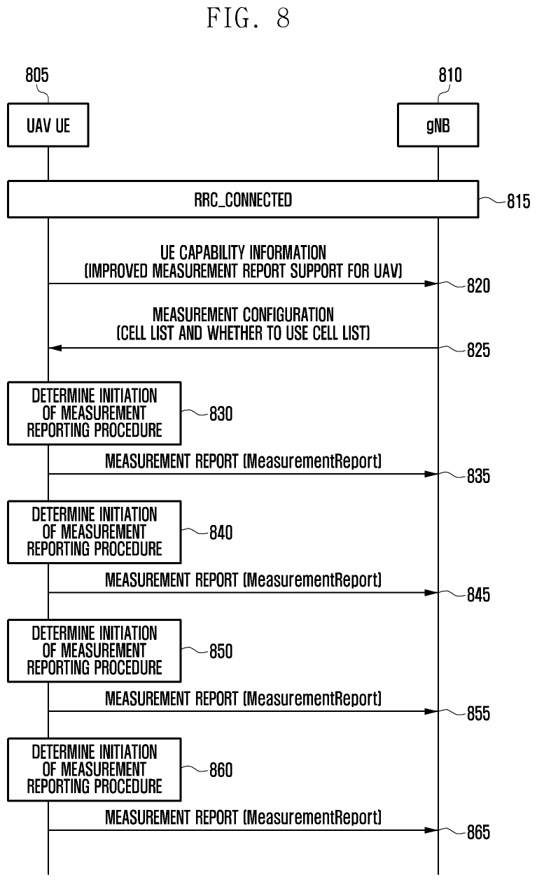

FIG. 8 is a diagram illustrating a process for the UAV UE to transmit improved measurement report to the base station in the next-generation mobile communication system according to an embodiment of the present disclosure.

Referring to FIG. 8, a UAV UE 805 may establish an RRC connection with an NR base station 810 and thus may be in an RRC connected mode (RRC_CONNECTED) 815.

In step 820, the UE may transmit the UE capability information (UECapabilityInformation) message to the base station. The transmission of the UE capability information message may follow the above-described examples (e.g., FIGS. 5, 6, and 7). Additionally, the UE capability information message may include a field for whether to support the improved measurement report for the UAV. The field may indicate whether the UE supports the capability to decide whether to transmit the measurement report based on the cell list configured by the base station.

In step 825, the base station may transmit an RRC message (e.g., RRCResume or RRCReconfiguration) including measurement configuration information (MeasConfig) to the UE. A method of transmitting an RRC message (e.g., RRCResume or RRCReconfiguration) may follow the above-described embodiments (e.g., FIGS. 5, 6, and 7). Additionally, the base station may configure a cell list including one or more cells for the improved measurement report and whether to use the cell list.

Method 1: A configuration method in the form of CellsToAddModList or allowedCellsToAddModList may follow the above-described example (e.g., FIG. 7).

In addition, an indicator indicating whether to use CellsToAddModList or allowedCellsToAddModList and numberOfTriggeringCells or improved measurement report may be included in the measurement configuration information to instruct that the designated Cell list is considered while the initiation of the measurement reporting procedure is determined. This may be used simultaneously with another list including blockedCellsToAddModList.

Method 2: It may be referred to as cellsToReportAddModList in the present disclosure, in the form including one or more physCellId. cellsToReportAddModList may be composed of AddModList and RemoveList supporting addition, modification and removal, or may be composed of one list. cellsToReportAddModList may be configured in one of the following forms as an embodiment, but is not limited thereto, and may include other forms of configuration that include one or more PCIs and include an offset for the corresponding PCI or do not include the offset. In addition, cellsToReportAddModList may be used simultaneously with another list that includes blockedCellsToAddModList.

| | |
|---|---|
| Form 1: | |
| rsportCellsToRemoveList | FCT-RangeIndexList |
| reportCellsToAddModList | SEQUENCE (SIZE (1. .maxNrofPCI-Ranges) ) |
| | OF PCI-RangeElement |
| Form 2: | |
| cellsToReportAddModList | PCI-List |
| PCI-List : := | SEQUENCE (SIZE (1. . maxNrofCellMeas) ) |
| | OF PhysCellId |

For convenience of description, it is assumed that the base station configures numberOfTriggeringCells to 3 and eventTriggered to EventA3 (of course, the eventTriggered may be configured to one of EventA4, EventA5, EventB1, EventB2 other than EventA3, or may be configured to another Event to which the numberOfTriggeringCells is applied), and configures cellsToReportAddModList so that Cell 1, Cell 4, and Cell 5 are included in cellsToReportAddModList.

In step 830, the UE may determine whether to initiate the measurement reporting procedure based on the measurement object information and the measurement configuration information received in step 825. When the entry condition for Cell 1 is fulfilled, the UE may include Cell 1 in the cellsTriggeredList. The UE may determine whether to initiate the measurement reporting procedure by using at least one combination of the following methods.

Method 1: The UE may initiate the measurement reporting procedure when at least one of the cells newly included in the cellsTriggeredList (i.e., cells that are not previously reported) is a cell included in cellsToReportAddModList.

Method 2: The UE may initiate the measurement reporting procedure when the number of cells included in cellsTriggeredList is larger than or equal to numberOfTriggeringCells when conditions related to cellsToReportAddModList are fulfilled.

Method 3: The UE may initiate the measurement reporting procedure when the conditions related to cellsToReportAddModList are fulfilled, regardless of the number of cells included in cellsTriggeredList and numberOfTriggeringCells.

Method 4: The UE may initiate the measurement reporting procedure when the number of cells included in cellsToReportAddModList among the cells included in cellsTriggeredList is larger than or equal to numberOfTriggeringCells.

As an embodiment, by using Method 1 and Method 3, the UE determines that Cell 1 newly included in cellsTriggeredList is included in cellsToReportAddModList in step 830 to fulfil the condition of Method 1, and may initiate the measurement reporting procedure regardless of numberOfTriggeringCells according to Method 3.

As another embodiment, by using a combination of Method 1 and Method 2, the UE determines that Cell 1 newly included in cellsTriggeredList, is included in cellsToReportAddModList in step 830 to fulfil the condition of Method 1, but determines that the condition of Method 2 is not fulfilled since the number of cells included in cellsTriggeredList is smaller than numberOfTriggeringCells, so the UE may not initiate the measurement reporting procedure.

As another embodiment, by using Method 4, the UE may determine that Cell 1 included in cellsTriggeredList is included in cellsToReportAddModList in step 830, but determine that the condition of method 4 is not fulfilled since the number of cells included in cellsTriggeredList among the cells in cellsToReportAddModList is smaller than numberOfTriggeringCells, so the UE may not initiate the measurement reporting procedure.

When the measurement reporting procedure is initiated, the UE may transmit the measurement report to the base station according to the above-described embodiments (e.g., FIGS. 5, 6, and 7) in step 835.

In step 840, the UE may determine whether to initiate the measurement reporting procedure based on the measurement configuration information received in step 825. That is, when Cell 1, Cell 2, and Cell 3 fulfil the entry condition of EventA3, the UE may include Cell 1, Cell 2, and Cell 3 in the cellsTriggeredList according to the above-described embodiment (e.g., FIGS. 5, 6, and 7) and determine whether to initiate the measurement reporting procedure.

In step 845, the UE may transmit the measurement report to the base station according to the above-described embodiment (e.g., FIG. 2).

In step 850, the UE may determine whether to initiate the measurement reporting procedure based on the measurement configuration information received in step 825. That is, when Cell 1, Cell 2, Cell 3, and Cell 4 fulfil the entry condition of EventA3, the UE may include Cell 1, Cell 2, Cell 3, and Cell 4 in the cellsTriggeredList.

As an embodiment, by using Method 1 and Method 2 of step 830 described above, the UE determines that Cell 4 newly included in cellsTriggeredList is included in cellsToReportAddModList in step 850 to fulfil the condition of Method 1, and may initiate the measurement reporting procedure regardless of numberOfTriggeringCells according to Method 3.

As another embodiment, by using Method 1 and Method 2 of step 830 described above, the UE determines that Cell 4 newly included in cellsTriggeredList, is included in cellsToReportAddModList in step 850 to fulfil the condition of Method 1, and determines that the condition of Method 2 is fulfilled since the number of cells included in cellsTriggeredList is larger than or equal to numberOfTriggeringCells, so the UE may initiate the measurement reporting procedure.

As another embodiment, by using Method 4 of step 830 described above, the UE may determine that Cell 1 and Cell 4 included in cellsTriggeredList is included in cellsToReportAddModList in step 850, but determine that the condition of method 4 is not fulfilled since the number of cells included in cellsToReportAddModList among the cells in cellsTriggeredList is smaller than numberOffriggeringCells, so the UE may not initiate the measurement reporting procedure.

In step 855, the UE may transmit the measurement report to the base station according to the above-described embodiment (e.g., FIGS. 5, 6, and 7).

In step 860, the UE may determine whether to initiate the measurement reporting procedure based on the measurement configuration information received in step 825. That is, when Cell 1, Cell 2, Cell 3, Cell 4, and Cell 5 fulfil the entry condition of EventA3, the UE may include Cell 1, Cell 2, Cell 3, Cell 4, and Cell 5 in the cellsTriggeredList.

As an embodiment, by using Method 1 and Method 2 of step 830 described above, the UE determines that Cell 5 newly included in cellsTriggeredList is included in cellsToReportAddModList in step 860 to fulfil the condition of Method 1, and may initiate the measurement reporting procedure regardless of numberOfTriggeringCells according to Method 3.

As another embodiment, by using Method 1 and Method 3 of step 830 described above, the UE determines that Cell 5 newly included in cellsTriggeredList, is included in cellsToReportAddModList in step 860 to fulfil the condition of Method 1, and determines that the condition of Method 2 is fulfilled since the number of cells included in cellsTriggeredList is larger than or equal to numberOfTriggeringCells, so the UE may initiate the measurement reporting procedure.

As another embodiment, by using Method 4 of step 830 described above, the UE may determine that Cell 1, Cell 4, and Cell 5 included in cellsTriggeredList is included in cellsToReportAddModList in step 860, and the condition of method 4 is fulfilled since the number of cells included in cellsToReportAddModList among the cells in cellsTriggeredList is larger than or equal to numberOffriggeringCells, so the UE may initiate the measurement reporting procedure.

In step 865, the UE may transmit the measurement report to the base station according to the above-described embodiment (e.g., FIG. 2).

Meanwhile, steps 830, 840, 850, and 860 are an embodiment disclosed to describe a method proposed to determine whether to initiate the measurement reporting procedure of the present disclosure, and not all steps are necessarily included. In the present disclosure, at least one of steps 830, 840, 850, or 860 may be included, and the UE may determine whether to initiate the measurement reporting procedure through one or a combination of at least two of the methods 1 to 4. In addition, in the present disclosure, for the convenience of description, initiating the measurement report in steps 830, 840, 850, and 860 is described as an example, but the measurement report may not be performed since the conditions for initiating the measurement reporting procedure are not fulfilled.

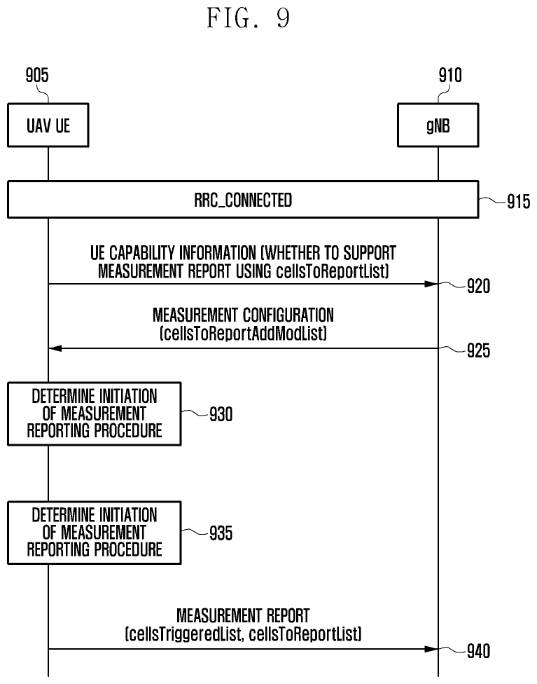

FIG. 9 is a diagram illustrating a process for the UAV UE to effectively transmit the measurement report to the base station in the next-generation mobile communication system according to an embodiment of the present disclosure.

Referring to FIG. 9, a UAV UE 905 may establish an RRC connection with an NR base station 910 and thus may be in an RRC connected mode (RRC_CONNECTED) 915.

In step 920, the UE may transmit the UE capability information (UECapabilityInformation) message to the base station. The transmission of the UE capability information message may follow the above-described examples (e.g., FIGS. 5, 6, 7, and 8). Additionally, the UE capability information message may include whether to support a measurement report using cellsToReportList. Whether to support the measurement report using cellsToReportList may indicate whether the UE has the capability to additionally include cells in cellsToReportList when transmitting the measurement report.

In step 925, the base station may transmit an RRC message (e.g., RRCResume or RRCReconfiguration) including measurement configuration information (MeasConfig) to the UE. A method of transmitting an RRC message (e.g., RRCResume or RRCReconfiguration) may follow the above-described embodiments (e.g., FIGS. 5, 6, 7, and 8). In this case, cellsToReportAddModList may designate the same object as cellsToReportAddModList of the above-described embodiments (e.g., FIG. 8) or other objects. When other objects are designated, names of cellsToReportAddModList of FIGS. 8 and 9 may be different. For convenience of description, it is assumed that cellsToReportAddModList of FIG. 8 and cellsToReportAddModList of FIG. 9 designate the same object. It is assumed that the base station configures numberOfTriggeringCells to 3 and eventTriggered to EventA3 (of course, the eventTriggered may be configured to one of EventA4, EventA5, EventB1, EventB2 other than EventA3, or may be configured to another Event to which the numberOfTriggeringCells is applied), and configures cellsToReportAddModList so that Cell 1, Cell 3, and Cell 4 are included in cellsToReportAddModList.

In step 930, the UE may determine whether to initiate the measurement reporting procedure based on the measurement object information and the measurement configuration information received in step 925. When the entry conditions for Cell 1, Cell 2, and Cell 3 are fulfilled, the UE may use the following method.

Method: When a cell is included in cellsToReportAddModList, it is included in cellsTriggeredList. When a cell is not included in cellsToReportAddModList, it is included in other lists (e.g., may be referred to as cellsToReportList).

In an embodiment, since Cell 1 and Cell 3 fulfil the entry conditions and are included in cellsToReportAddModList, the UE may include the cell in cellsTriggeredList. Since Cell 2 fulfills the entry conditions but is not included in cellsToReportAddModList, it may be included in cellsToReportList. The subsequent determination of the measurement reporting procedure may follow the examples described above (e.g., FIGS. 5, 6, 7, and 8). For example, the UE may not initiate the measurement reporting procedure since the number of cells included in cellsTriggeredList is smaller than the numberOfTriggeringCells. However, this is only an embodiment, and the measurement reporting procedure may be initiated according to the number of configured numberOfTriggeringCells and the number of cells fulfilling the entry condition.

In step 935, the UE may determine whether to initiate the measurement reporting procedure based on the measurement object information and the measurement configuration information received in step 925. The UE may include cells in cellsTriggeredList or cellsToReportList according to the method of step 930 when the entry conditions for Cell 1, Cell 2, Cell 3, and Cell 4 are fulfilled. In an embodiment, since Cell 1, Cell 3, and Cell 4 fulfil the entry conditions and are included in cellsToReportAddModList, the UE may include the cell in cellsTriggeredList. Since Cell 2 fulfills the entry condition but is not included in cellsToReportAddModList, it may be included in cellsToReportList. The subsequent determination of the measurement reporting procedure may follow the examples described above (e.g., FIGS. 5, 6, 7, and 8). The UE may initiate the measurement reporting procedure since the number of cells included in the cellsTriggeredList is larger than or equal to numberOfTriggeringCells.

In step 940, the UE may transmit the measurement report to the base station according to the above-described embodiment (e.g., FIGS. 5, 6, 7, and 8). Additionally, when there are cells included in cellsToReportList, and the number of cells included in cellsTriggeredList is smaller than maxReportCells included in the measurement reporting configuration information, the UE may add cells included in cellsToReportList up to maxReportCells and transmit the measurement report to the base station. When the cells included in cellsToReportList are included in the measurement report, the UE may preferentially include cells with good measurement quantities included in the measurement configuration such as RSRP, RSRQ, and SINR of cells received in step 925.

Meanwhile, steps 930 and 935 are an embodiment disclosed to describe the method proposed to determine whether to initiate the measurement reporting procedure of the present disclosure, and not all steps are necessarily included. In addition, as described above, whether to initiate the measurement reporting procedure may be changed depending on a value of numberOfTriggeringCells and the number of cells fulfilling the entry in the above embodiment.

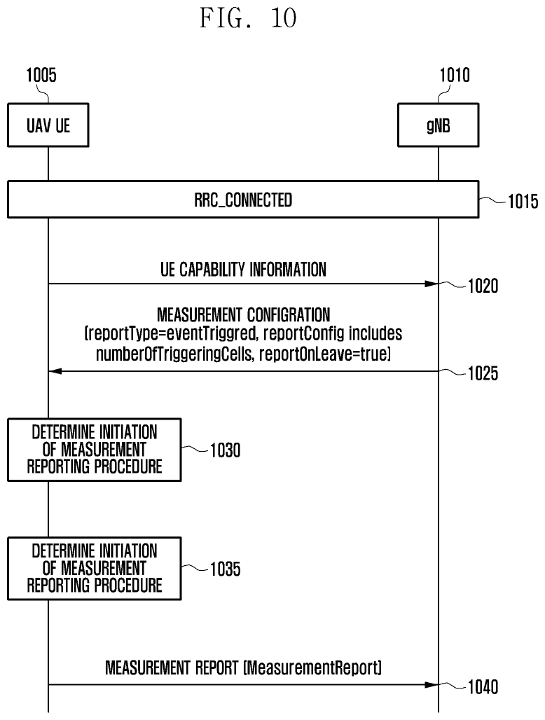

FIG. 10 is a diagram illustrating a process for the UAV UE to transmit a leaving condition-based measurement report to the base station in the next-generation mobile communication system according to an embodiment of the present disclosure.

Referring to FIG. 10, a UAV UE 1005 may establish an RRC connection with an NR base station 1010 and thus may be in an RRC connected mode (RRC_CONNECTED) 1015.

In step 1020, the UE may transmit the UE capability information (UECapabilityInformation) message to the base station. The transmission of the UE capability information message may follow the above-described examples (e.g., FIGS. 5, 6, 7, 8, and 9).

In step 1025, the base station may transmit an RRC message (e.g., RRCResume or RRCReconfiguration) including measurement configuration information (MeasConfig) to the UE. A method of transmitting an RRC message (e.g., RRCResume or RRCReconfiguration) may follow the above-described embodiments (e.g., FIGS. 5, 6, 7, 8, and 9). For convenience of description, it is assumed that the base station configures numberOfTriggeringCells to 3 and eventTriggered to EventA3 (of course, the eventTriggered may be configured to one of EventA4, EventA5, EventB1, EventB2 other than EventA3, or may be configured to another Event to which the numberOfTriggeringCells is applied), and configure reportOnLeave to TRUE.

In step 1030, the UE may determine whether to initiate the measurement reporting procedure based on the measurement object information and the measurement configuration information received in step 1025. When the entry conditions for Cell 1 and Cell 2 are fulfilled, the UE may include Cell 1 and Cell 2 in the cellsTriggeredList. The UE may not initiate the measurement reporting procedure since the number of cells included in cellsTriggeredList is smaller than the numberOfTriggeringCells. However, this is only an embodiment, and the measurement reporting procedure may be initiated according to the number of configured numberOfTriggeringCells and the number of cells fulfilling the entry condition.

In step 1035, the UE may determine whether to initiate the measurement reporting procedure based on the measurement object information and the measurement configuration information received in step 1025. When the leaving condition for Cell 2 is fulfilled, the UE may remove Cell 2 from cellsTriggeredList. The UE may initiate the measurement reporting procedure when reportOnLeave is configured to TRUE. Specifically, the UE may initiate the measurement reporting procedure when at least one of the following conditions is fulfilled.

```
2> if the reportType is set to eventTriggered and if the leaving condition applicable for
  this event is fulfilled for one or more of the cells included in the cells TriggeredList
  defined within the VarMeasReportList for this measId for all measurements after layer
  3 filtering taken during timeToTrigger defined within the VarMeasConfig for this
  event:
  3> remove the concerned cell(s) in the cellsTriggeredList defined within the
      VarMeasReportList for this measId;
  3> if reportOnLeave is set to true for the corresponding reporting configuration:
      4> initiate the measurement reporting procedure, as specified in 5.5.5;
  3> if the cellsTriggeredList defined within the VarMeasReportList for this measId is
    empty:
    4> remove the measurement reporting entry within the VarMeasReportList for this
        measId;
    4> stop the periodical reporting timer for this measId, if running;
```

In step 1040, the UE may transmit the measurement report to the base station according to the above-described embodiment (e.g., FIGS. 5, 6, 7, 8, and 9). In this case, the UE may transmit the measurement report even if the number of cells included in the cellsTriggeredList of the UE is smaller than the numberOffriggeringCells configured by the base station. This may be the measurement report not intended by the base station.

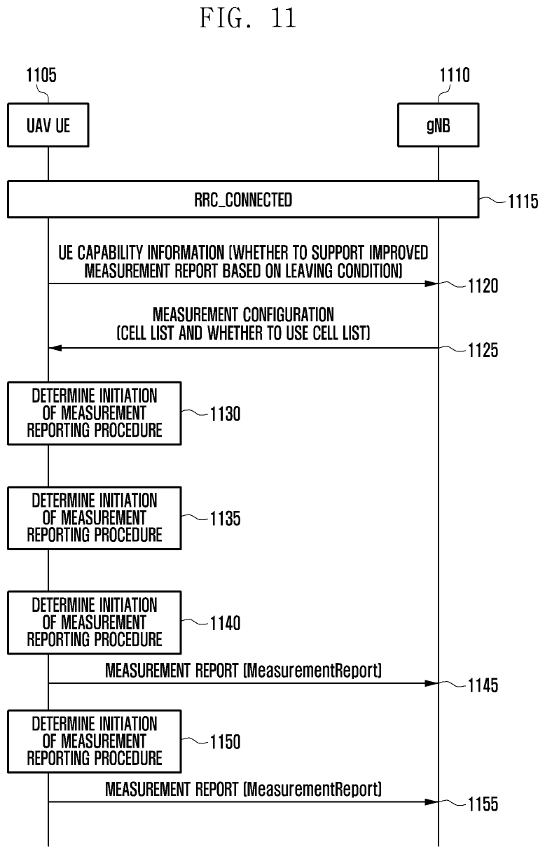

FIG. 11 is a diagram illustrating a process for the UAV UE to transmit the leaving condition-based improved measurement report to the base station in the next-generation mobile communication system according to an embodiment of the present disclosure.

Referring to FIG. 11, a UAV UE 1105 may establish an RRC connection with an NR base station 1110 and thus may be in an RRC connected mode (RRC_CONNECTED) 1115.

In step 1120, the UE may transmit the UE capability information (UECapabilityInformation) message to the base station. The transmission of the UE capability information message may follow the above-described examples (e.g., FIGS. 5, 6, 7, 8, 9, and 10). Additionally, the message may include whether to support a leaving condition-based improved measurement report. Whether to support the leaving condition-based improved measurement report may indicate whether to support the capability to decide whether to transmit the measurement report when at least one of cells included in a cell list configured by the base station fulfills the leaving condition when the UE determines whether to transmit the measurement report.

In step 1125, the base station may transmit an RRC message (e.g., RRCResume or RRCReconfiguration) including measurement configuration information (MeasConfig) to the UE. A method of transmitting an RRC message (e.g., RRCResume or RRCReconfiguration) may follow the above-described embodiments (e.g., FIGS. 5, 6, 7, 8, 9, and 10). Additionally, the base station may configure a cell list including one or more cells and whether to use the cell list for the leaving condition-based improved measurement report.

Method 1: A configuration method in the form of CellsToAddModList or allowedCellsToAddModList may follow the above-described example (e.g., FIG. 7).

In addition, an indicator indicating whether to use CellsToAddModList or allowedCellsToAddModList and numberOfTriggeringCells or improved measurement report may be included in the measurement configuration information to instruct that the designated Cell list is considered during the initiate determination of the leaving condition-based measurement reporting procedure. This may be used simultaneously with another list including blockedCellsToAddModList.

Method 2: It may be referred to as cellsToReportOnLeaveAddModList in the present disclosure, in the form including one or more physCellId. cellsToReportOnLeaveAddModList may be composed of AddModList and RemoveList supporting addition, modification and removal, or may be composed of one list. cellsToReportOnLeaveAddModList may be configured in one of the following forms as an embodiment, but is not limited thereto, and may include other forms of configuration that include one or more PCIs and include an offset for the corresponding PCI or do not include the offset. Alternatively, cellsToReportOnLeaveAddModList may be used simultaneously with another list that includes blockedCellsToAddModList.

| | |
|---|---|
| Form 1: | |
| reportonleaveCellsToRemoveList | PCI-RangeIndexLisst |
| reportOnLeaveCellsToAddModList | SEQUENCE (SIZE (1. . maxNrofPCI-Banges) ) |
| | OF PCI-RangeElement |
| Form 2: | |
| cellsToReportOnLeaveAddModList | PCI-List |
| PCI-List ::= | SEQUENCE (SIZE (1..maxNrofCellMeas) ) |
| | OF PhysCellId |

For convenience of description, it is assumed that the base station configures numberOfTriggeringCells to 3 and eventTriggered to EventA3 (of course, the eventTriggered may be configured to one of EventA4, EventA5, EventB1, EventB2 other than EventA3, or may be configured to another Event to which the numberOfTriggeringCells is applied), configures cellsToReportOnLeaveAddModList so that Cell 1, Cell 3, and Cell 4 are included in cellsToReportOnLeaveAddModList, and configures reportOnLeave to TRUE.

In step 1130, the UE may determine whether to initiate the measurement reporting procedure based on the measurement object information and the measurement configuration information received in step 1125. The UE may include Cell 1 and Cell 2 in cellsTriggeredList when the entry conditions for Cell 1 and Cell 2 are fulfilled. The UE may not initiate the measurement reporting procedure since the number of cells included in cellsTriggeredList is smaller than the numberOfTriggeringCells.

In step 1135, the UE may determine whether to initiate the measurement reporting procedure based on the measurement object information and the measurement configuration information received in step 1125. When the leaving condition for Cell 2 is fulfilled, the UE may remove Cell 2 from cellsTriggeredList. The UE may determine whether to initiate the leaving condition-based measurement reporting procedure by using at least one combination of the following methods.

Method 1. When at least one cell fulfilling the leaving condition is included in cellsToReportOnLeaveAddModList, the UE may initiate the measurement reporting procedure.

Method 2: When the number of cells included in cellsTriggeredList is larger than or equal to numberOffriggeringCells after at least one cell fulfilling the leaving condition is removed from cellsTriggeredList, the UE may initiate the measurement reporting procedure. In this case, numberOfTriggeringCells used for the leaving condition may be a different value from numberOffriggeringCells used for determining the initiation of the measurement reporting procedure, and may be configured to different names.

As an example, by using Method 1, the UE may not initiate the measurement reporting procedure since it is determined that Cell 2, which fulfills the leaving condition in step 1120, is not included in cellsToReportOnLeaveAddModList and thus does not fulfill the condition of method 1.

In step 1140, the UE may determine whether to initiate the measurement reporting procedure based on the measurement object information and the measurement configuration information received in step 1125. When the entry conditions for Cell 1, Cell 3, Cell 4, and Cell 5 are fulfilled, the UE may include Cell 1, Cell 3, Cell 4, and Cell 5 in cellsToReportList according to the above-described examples (e.g., FIGS. 5, 6, 7, 8, 9, and 10).

In step 1145, the UE may transmit the measurement report to the base station according to the above-described embodiment (e.g., FIGS. 5, 6, 7, 8, 9, and 10).

In step 1150, the UE may determine whether to initiate the measurement reporting procedure based on the measurement object information and the measurement configuration information received in step 1125. When the leaving condition for Cell 4 is fulfilled, the UE may remove Cell 4 from cellsTriggeredList.

As an embodiment, when Method 1 of step 1135 described above is used, the UE may initiate the measurement reporting procedure since it is determined that Cell 4, which fulfills the leaving condition in step 1150, is included in cellsToReportOnLeaveAddModList and thus fulfills the condition of Method 1.

In another embodiment, by using the combination of Methods 1 and 2 of the above-described step 1135, the UE determined that Cell 4, which fulfills the leaving condition in step 1150, is included in cellsToReportOnLeaveAddModList to fulfil the condition of Method 1, and determines that the condition of Method 2 is fulfilled since the number of cells included in cellsTriggeredList is larger than or equal to numberOfTriggeringCells, so the UE may initiate the measurement reporting procedure.

In step 1155, the UE may transmit the measurement report to the base station according to the above-described embodiment (e.g., FIGS. 5, 6, 7, 8, 9, and 10).

Meanwhile, the above-described steps 1130, 1135, 1140, and 1150 are an embodiment disclosed to describe the proposed method of the present disclosure, and not all steps are necessarily included. In the present disclosure, at least one of steps 1130, 1135, 1140, or 1150 may be included, and the UE may determine whether to initiate the measurement reporting procedure through one or a combination of at least two of the methods 1 and 2. In addition, in the present disclosure, for convenience of description, initiating a measurement report in steps 1140 and 1150 is described as an example, but whether to initiate the measurement report in each step may change depending on the number of cells included in cellsTriggeredList, the number of cells fulfilling the leaving condition, and the value of the configured numberOfTriggeringCelIs.

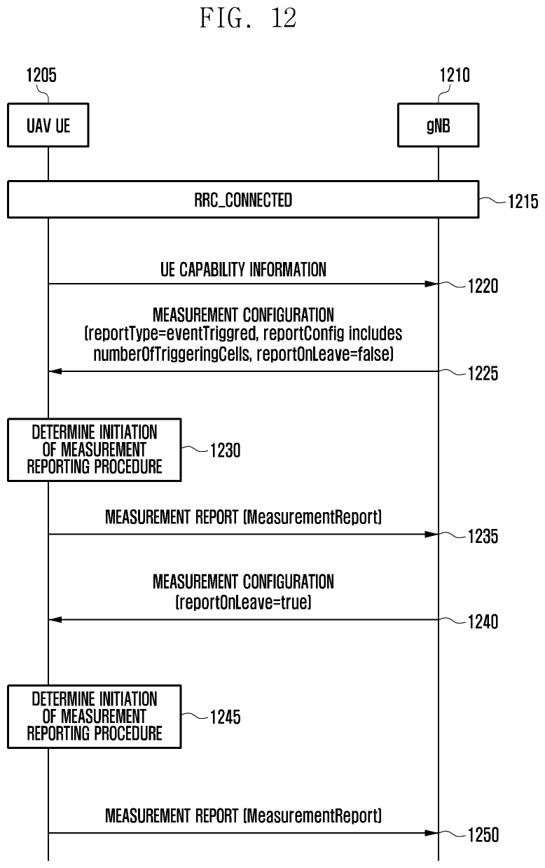

FIG. 12 is a diagram illustrating a process for the UAV UE to transmit a measurement report by a measurement reporting configuration change to the base station in the next-generation mobile communication system according to an embodiment of the present disclosure.

Referring to FIG. 12, a UAV UE 1205 may establish an RRC connection with an NR base station 1210 and thus may be in an RRC connected mode (RRC_CONNECTED) 1215.

In step 1220, the UE may transmit the UE capability information (UECapabilityInformation) message to the base station. The transmission of the UE capability information message may follow the above-described examples (e.g., FIGS. 5, 6, 7, 8, 9, 10, and 11).

In step 1225, the base station may transmit an RRC message (e.g., RRCResume or RRCReconfiguration) including measurement configuration information (MeasConfig) to the UE. A method of transmitting an RRC message (e.g., RRCResume or RRCReconfiguration) may follow the above-described embodiments (e.g., FIGS. 2, 5, 6, or 8).

For convenience of description, it is assumed that the base station configures numberOfTriggeringCells to 3 and eventTriggered to EventA3 (of course, the eventTriggered may be configured to one of EventA4, EventA5, EventB1, EventB2 other than EventA3, or may be configured to another Event to which the numberOfTriggeringCells is applied), and configure reportOnLeave to FALSE.

In step 1230, the UE may determine whether to initiate the measurement reporting procedure based on the measurement object information and the measurement configuration information received in step 1225. When the entry conditions for Cell 1, Cell 2, and Cell 3 are fulfilled, the UE may include Cell 1, Cell 2, and Cell 3 in the cellsTriggeredList. The UE may initiate the measurement reporting procedure since the number of cells included in cellsTriggeredList is larger than or equal to numberOfTriggeringCelIs.

In step 1235, the UE may transmit the measurement report to the base station according to the above-described embodiment (e.g., FIGS. 5, 6, 7, 8, 9, 10, and 11).

In step 1240, in order to configure reportOnLeave to TRUE, the base station may transmit an RRC message (e.g., RRCResume or RRCReconfiguration) including measurement configuration information (MeasConfig) to the UE. A method of transmitting an RRC message (e.g., RRCResume or RRCReconfiguration) may follow the above-described embodiments (e.g., FIGS. 5, 6, 7, 8, 9, 10, and 11).

The UE may receive the measurement configuration information and apply reportOnLeave as TRUE. In this case, the measurement reporting entry held by the UE may be removed. For example, the measurement reporting entry held by the UE may be removed when at least one of the following conditions is fulfilled. Specifically, when at least one of the contents included in the measurement configuration information (MeasConfig), the measurement object information (measObjectToAddModList) included in the measurement configuration information, or the reporting configuration information (reportConfigToAddModList) included in the measurement configuration information is configured to be added, changed, or removed, the UE may remove the reporting entry including the measurement result based on the previous configuration.

```
5.5.2.3  Measurement identity addition/modification
The network applies the procedure as follows:
  - configure a measId only if the corresponding measurement object, the corresponding
    reporting configuration and the corresponding quantity configuration, are configured.
The UE shall:
  1> for each measId included in the received measIdToAddModList:
    2> if an entry with the matching measId exists in the measIdList within the
      VarMeasConfig:
      3> replace the entry with the value received for this measId;
    2> else:
      3> add a new entry for this measId within the VarMeasConfig;
    2> remove the measurement reporting entry for this measId from the VarMeasReportList,
      if Included;
    2> stop the periodical reporting timer or timer T321 or timer T322, whichever one is
      running, and reset the associated information (e.g. timeToTrigger) for this measId;
  NOTE 1:  If the measId associated with reportConfig for conditional reconfiguration is
      modified, the conditions are considered to be not fulfilled as specified in 5.3.5.13.4.
    2> if the reportType is set to reportCGI in the reportConfig associated with this measId:
      3> if the measObject associated with this measId concerns E-UTRA:
          4> if the useAutonomousGaps is included in the reportConfig associated with this
            measId:
            5> start timer T321 with the timer value set to 200 ms for this measId;
          4> else:
            5> start timer T321 with the timer value set to 1 second for this measId;
      3> if the measObject associated with this measId concerns NR:
          4> if the measObject associated with this measId concerns FR1:
            5> if the useAutonomousGaps is included in the reportConfig associated with this
              measId:
              6> if the UE is a RedCap UE with 1 Rx branch
                7> start timer T321 with the timer value set to 3 seconds for this measId;
              6> else
                  7> start timer T321 with the timer value set to 2 seconds for this measId;
              5> else:
              6> start timer T321 with the timer value set to 2 seconds for this measId;
        4> if the measObject associated with this measId concerns FR2:
            5> if the useAutonomousGaps is included in the reportConfig associated with this
                measId:
                6>  if the UE is a RedCap UE with 1 Rx branch
                7> start timer T321 with the timer value set to 6 seconds for this measId;
                6> else
                  7> start timer T321 with the timer value set to 5 seconds for this measId;
        5> else:
            6> start timer T321 with the timer value set to 16 seconds for this measId.
    2> if the reportType is set to reportSFTD in the reportConfigNR associated with this
      measId and the drx-SFTD-NeighMeas is included;
      3> if the measObject associated with this measId concerns FR1:
          4> start timer T322 with the timer value set to 3 seconds for this measId;
      3> if the measObject associated with this measId concerns FR2:
          4> start timer T322 with the timer value set to 24 seconds for this measId.
5.5.2.5  Measurement object addition/modification
The UE shall:
  1> for each measObjectId included in the received measObjectToAddModList:
    2> if an entry with the matching measObjectId exists in the measObjectList within the
        VarMeasConfig, for this entry:
        3> reconfigure the entry with the value received for this measObject, except for the
            fields  cellsToAddModList,  excludedCellsToAddModList,
            allowedCellsToAddModList, cellsToRemoveList, excludedCellsToRemoveList,
            allowedCellsToRemoveList,  tx-PoolMeasToRemoveList,  tx-
            PoolMeasToAddModList,  ssb-PositionQCL-CellsToRemoveList,  and ssb-
            PositionQCL-CellsToAddModList;
        3> if the received measObject includes the cellsToRemoveList:
          4> for each physCellId included in the cellsToRemoveList:
              5> remove the entry with the matching physCellld from the cellsToAddModList:
        3> if the received measObject includes the cellsToAddModList:
          4> for each physCellId value included in the cellsToAddModList:
              5> if an entry with the matching physCellId exists in the cellsToAddModList:
                6> replace the entry with the value received for this physCellId;
              5> else:
                6> add a new entry for the received physCellId to the cellsToAddModList;
        3> if the received measObject includes the excludedCellsToRemoveList:
            4> for each pci-RangeIndex included in the excludedCellsToRemoveList:
              5> remove the entry with the matching pci-RangeIndex from the
                excludedCellsToAddModList;
NOTE 1:  For each pci-RangeIndex included in the excludedCellsToRemoveList that
    concerns overlapping ranges of cells, a cell is removed from the exclude-list of cells
    only if all PCI ranges containing it are removed.
  3> if the received measObject includes the excludedCellsToAddModList:
    4> for each pci-RangeIndex included in the excludedCellsToAddModList:
        5> if an entry with the matching pci-RangeIndex is included in the
          excludedCellsToAddModList:
          6> replace the entry with the value received for this pci-RangeIndex;
        5> else:
          6> add a new entry for the received pci-RangeIndex to the
              excludedCellsToAddModList;
  3> if the received measObject includes the allowedCellsToRemoveList:
    4> for each pci-RangeIndex included in the allowedCellsToRemoveList:
        5> remove the entry with the matching pci-RangeIndex from the
          allowedCellsToAddModList;
NOTE2: For each pci-RangeIndex included in the allowedCellsToRemoveList that concerns
        overlapping ranges of cells, a cell is removed from the allow-list of cells only if all
        PCI ranges containing it are removed.
    3> if the received measObject includes the allowedCellsToAddModList:
        4> for each pci-RangeIndex included in the allowedCellsToAddModList:
          5> if an entry with the matching pci-RangeIndex is included in the
            allowedCellsToAddModList:
            6> replace the entry with the value received for this pci-RangeIndex;
          5> else:
            6> add a new entry for the received pci-RangeIndex to the
                allowedCellsToAddModList
    3> for each measId associated with this measObjectId in the measIdList within the
        VarMeasConfig, if any:
    4> remove the measurement reporting entry for this measId from the
      VarMeasReportList, if included;
    4> stop the periodical reporting timer or timer T321 or timer T322, whichever one
        is running, and reset the associated information (e.g. timeToTrigger) for this
        measId;
    3> if the received measObject includes the tx-PoolMeasToRemoveList:
      4> for each transmission resource pool indicated in tx-PoolMeasToRemoveList:
          5> remove the entry with the matching identity of the transmission resource pool
            from the tx-PoolMeasToAddModList;
    3> if the received measObject includes the tx-PoolMeasToAddModList:
      4> for each transmission resource pool indicated in tx-PoolMeasToAddModList:
          5> if an entry with the matching identity of the transmission resource pool exists
            in the tx-PoolMeasToAddModList:
            6> replace the entry with the value received for this transmission resource
                pool:
          5> else:
            6> add a new entry for the received identity of the transmission resource pool
                to the tx-PoolMeasToAddModList;
    3> if the received measObject includes the ssb-PositionQCL-CellsToRemoveList:
      4> for each physCellld included in the ssb-PositionQCL-CellsToRemoveList:
          5> remove the entry with the matching physCellId from the ssb-PositionQCL-
            CellsToAddModList;
    3> if the received measObject includes the ssb-PositionQCL-CellsToAddModList:
      4> for each physCellId included in the ssb-PositionQCL-CellsToAddModList:
        5> if an entry with the matching physCellId exists in the ssb-PositionQCL-
          CellsToAddModList:
          6> replace the entry with the value received for this physCellId;
        5> else:
          6> add a new entry for the received physCellId to the ssb-PositionQCL-
              CellsToAddModList;
    2> else:
        3> add a new entry for the received measObject to the measObjectList within
          VarMeasConfig.
5.5.2.7  Reporting configuration addition/modification
The UE shall:
  1> for each reportConfigId included in the received reportConfigToAddModList:
    2> if an entry with the matching reportConfigId exists in the reportConfigList within the
      VarMeasConfig, for this entry:
      3> reconfigure the entry with the value received for this reportConfig:
      3> for each measId associated with this reportConfigId included in the measIdList
          within the VarMeasConfig, if any:
          4> remove the measurement reporting entry for this measId from the
            VarMeasReportList, if included;
          4> stop the periodical reporting timer or timer T321 or timer T322, whichever one
            is running, and reset the associated information (e.g. timeToTrigger) for this
            measId;
    2> else:
        3> add a new entry for the received reportConfig to the reportConfigList within the
          VarMeasConfig.
5.5.2.8  Quantity configuration
The UE shall:
  1> for each RAT for which the received quantityConfig includes parameter(s):
      2> set the corresponding parameter(s) in quantityConfig within VarMeasConfig to the
        value of the received quantityConfig parameter(s);
  1> for each measId included in the measIdList within VarMeasConfig:
      2> remove the measurement reporting entry for this measId from the VarMeasReportList,
        if included;
      2> stop the periodical reporting timer or timer T321 or timer T322, whichever one is
        running, and reset the associated information (e.g. timeToTrigger) for this measId.
```

In step 1245, the UE may determine whether to initiate the measurement reporting procedure based on the measurement object information and the measurement configuration information received in step 1240. When the entry conditions for Cell 1, Cell 2, and Cell 3 are fulfilled, the UE may include the above-described cells in cellsTriggeredList. The UE may initiate the measurement reporting procedure since the number of cells included in cellsTriggeredList is larger than or equal to numberOfTriggeringCells.

In step 1250, the UE may transmit the measurement report to the base station according to the above-described embodiment (e.g., FIGS. 5, 6, 7, 8, 9, 10, and 11). An additional measurement report due to the change in the configuration of the base station may cause signaling overhead.

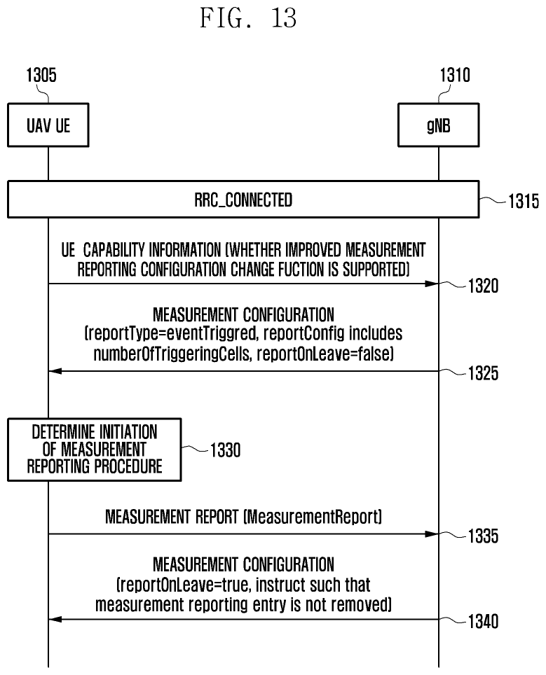

FIG. 13 is a diagram illustrating a process for the base station to transmit an improved measurement reporting configuration change to the UAV UE in the next-generation mobile communication system according to an embodiment of the present disclosure.

Referring to FIG. 13, a UAV UE 1305 may establish an RRC connection with an NR base station 1310 and thus may be in an RRC connected mode (RRC_CONNECTED) 1315.

In step 1320, the UE may transmit the UE capability information (UECapabilityInformation) message to the base station. The transmission of the UE capability information message may follow the above-described examples (e.g., FIGS. 5, 6, 7, 8, 9, 10, 11, and 12). Additionally, the UE capability information message may include whether to support an improved measurement reporting configuration change function. Whether to support the improved measurement reporting configuration change function indicates whether the UE has the capability to change the measurement reporting configuration without removing the measurement reporting entry held by the UE when the base station transmits a message changing the measurement reporting configuration to the UE.

In step 1325, the base station may transmit an RRC message (e.g., RRCResume or RRCReconfiguration) including measurement configuration information (MeasConfig) to the UE. A method of transmitting an RRC message (e.g., RRCResume or RRCReconfiguration) may follow the above-described embodiments (e.g., FIGS. 5, 6, 7, 8, 9, 10, 11, and 12). For convenience of description, it is assumed that the base station configures numberOfTriggeringCells to 3 and eventTriggered to EventA3 (of course, the eventTriggered may be configured to one of EventA4, EventA5, EventB1, EventB2 other than EventA3, or may be configured to another Event to which the numberOfTriggeringCells is applied), and configure reportOnLeave to FALSE.

In step 1330, the UE may determine whether to initiate the measurement reporting procedure based on the measurement object information and the measurement configuration information received in step 1225. When the entry conditions for Cell 1, Cell 2, and Cell 3 are fulfilled, the UE may include Cell 1, Cell 2, and Cell 3 in the cellsTriggeredList. The UE may initiate the measurement reporting procedure since the number of cells included in cellsTriggeredList is larger than or equal to numberOfTriggeringCells.

In step 1335, the UE may transmit the measurement report to the base station according to the above-described embodiment (e.g., FIGS. 5, 6, 7, 8, 9, 10, 11, and 12).

In step 1340, in order to configure reportOnLeave to TRUE, the base station may transmit an RRC message (e.g., RRCResume or RRCReconfiguration) including measurement configuration information (MeasConfig) to the UE. A method of transmitting an RRC message (e.g., RRCResume or RRCReconfiguration) may follow the above-described embodiments (e.g., FIGS. 5, 6, 7, 8, 9, 10, 11, and 12). Additionally, the base station may transmit an indicator indicating not to remove the measurement reporting entry held by the UE by including the indicator in the measurement configuration information. The indicator indicating not to remove the measurement reporting entry may be indicated by at least one combination of at least one measurement object configuration, at least one measurement reporting configuration, or measurement configuration information.

The UE may receive the measurement configuration information and apply reportOnLeave as TRUE. In this case, when the indicator indicating not to remove the measurement reporting entry held by the UE is included, the UE may not remove the measurement reporting entry held by the UE for an event associated with the indicated measurement object, an event associated with the indicated measurement configuration, or an event associated with the measurement configuration information. Since the measurement reporting entry is not removed, the UE may not transmit an additional measurement report since the number of cells included in cellsTriggeredList may remain larger than or equal to numberOfTriggeringCells.

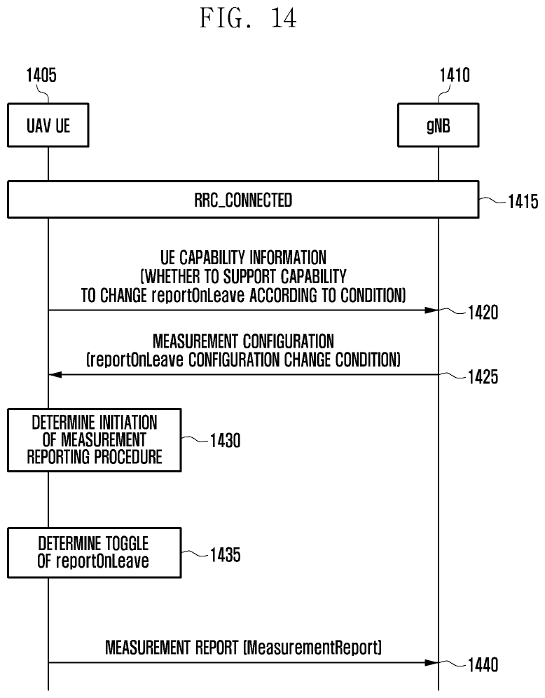

FIG. 14 is a diagram illustrating a process for the UAV UE to change reportOnLeave according to conditions in the next-generation mobile communication system according to an embodiment of the present disclosure.

Referring to FIG. 14, a UAV UE 1405 may establish an RRC connection with an NR base station 1410 and thus may be in an RRC connected mode (RRC_CONNECTED) 1415.

In step 1420, the UE may transmit the UE capability information (UECapabilityInformation) message to the base station. The transmission of the UE capability information message may follow the above-described examples (e.g., FIGS. 5, 6, 7, 8, 9, 10, 11, 12, and 13). Additionally, the UE capability information message may include whether to support the capability to change reportOnLeave according to the condition. Whether to support the capability to change reportOnLeave according to the condition indicates whether the UE has the capability to change reportOnLeave to TRUE or FALSE according to the condition configured by the base station.

In step 1425, the base station may transmit an RRC message (e.g., RRCResume or RRCReconfiguration) including measurement configuration information (MeasConfig) to the UE. A method of transmitting an RRC message (e.g., RRCResume or RRCReconfiguration) may follow the above-described embodiments (e.g., FIGS. 5, 6, 7, 8, 9, 10, 11, 12, and 13). Additionally, a condition to configure reportOnLeave to TRUE and a condition to configure reportOnLeave to FALSE may be included. Specifically, a combination of at least one of the following methods may be used.
Method 1: When an entry or leaving condition of a specific event is fulfilled, reportOnLeave is applied as TRUE or FALSE. The specific event may follow the above-described examples (e.g., FIG. 5), and can also be applied to other events that are not specified.
Method 2: When a specific interference condition is fulfilled or not fulfilled, reportOnLeave is applied as TRUE or FALSE. The specific interference condition may be a sum of RSRPs of all interference cells or a specific threshold for the sum of RSRPs of at least one specific cell.
Method 3: When a specific location condition is fulfilled or not fulfilled, reportOnLeave is applied as TRUE or FALSE. The specific location condition may be in the form of a range including a location and a rectangle or circle with the location as its center, or an identity representing the range.
Method 4: When a specific path condition is fulfilled or not fulfilled, reportOnLeave is applied as TRUE or FALSE. The specific path condition may be a part of a flight path reported by the UE.

In step 1430, the UE may determine whether to initiate the measurement reporting procedure based on the measurement object information and the measurement configuration information received in step 1425. The determination of the initiation of the measurement reporting procedure may follow the examples described above (e.g., FIGS. 5, 6, 7, 8, 9, 10, 11, 12, and 13).

In step 1435, the UE may configure reportOnLeave to TRUE or FALSE according to the method configured in step 1425.

As an example, by using Method 1 of step 1425 described above, a condition to configure reportOnLeave to TRUE for an event fulfilling the entry condition is included, and when the event fulfilling the entry condition occurs, the UE may configure reportOnLeave to TRUE.

As another example, by using Method 2 of step 1425 described above, when the sum of RSRP values of surrounding interference cells is larger than or equal to a threshold, a condition to configure reportOnLeave to TRUE is included, and when the sum of RSRP values of the surrounding interference cells is larger than or equal to the threshold, the UE may configure reportOnLeave to TRUE.

As another example, by using Method 3 of step 1425 described above, when the UE enters a specific location or range, a condition to configure reportOnLeave to TRUE is included, and when the UE recognizes that it enters the specific location or range, the UE may configure reportOnLeave to TRUE.

As another example, by using Method 4 of step 1425 described above, when the UE enters a specific path, a condition to configure reportOnLeave to TRUE is included, and when the UE recognizes that it has entered the specific path, the UE may configure reportOnLeave to TRUE.

In step 1440, the UE may transmit the measurement report to the base station according to the above-described embodiment (e.g., FIGS. 5, 6, 7, 8, 9, 10, 11, 12, and 13).

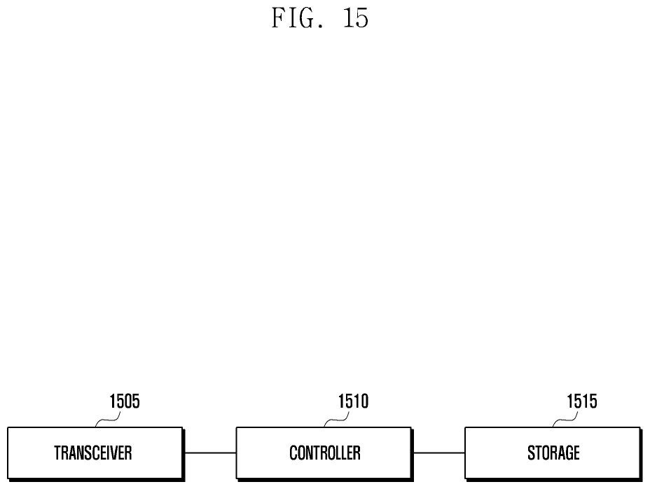

FIG. 15 is a diagram illustrating a structure of a base station according to an embodiment of the present disclosure.

Referring to FIG. 15, the base station may include a transceiver 1505, a controller 1510, and a storage 1515. According to the communication method of the base station described above, the transceiver 1505, the controller 1510, and the storage 1515 may operate. The network entity may also correspond to the structure of the base station. However, the components of the base station are not limited to the above-described examples. For example, the base station may include more or fewer components than the above-described components. For example, the base station may include the transceiver 1505 and the controller 1510. In addition, the transceiver 1505, the controller 1510, and the storage 1515 may be implemented in the form of a single chip.

The transceiver 1505 refers collectively to a receiver of the base station and a transmitter of the base station, and may transmit and receive signals to and from terminals, other base stations, or other network entities. In this case, the transmitted and received signal may include control information and data. The transceiver 1505 may transmit system information to the terminal, for example, and transmit a synchronization signal or a reference signal. To this end, the transceiver 1505 may be composed of an RF transmitter that up-converts a frequency of the transmitted signal and amplifies the transmitted signal, an RF receiver that low-noise amplifies the received signal and down-converts a frequency of the received signal, etc. However, this is only an embodiment of the transceiver 1505, and the components of the transceiver 1505 are not limited to the RF transmitter and the RF receiver. The transceiver 1505 may include a wired and wireless transceiver, and may include various components for transmitting and receiving a signal. In addition, the transceiver 1505 may receive a signal through a communication channel (e.g., a wireless channel) and output the received signal to the controller 1510, and transmit the signal output from the controller 1510 through the communication channel. In addition, the transceiver 1505 may receive a communication signal and output the received communication signal to a processor, and transmit the signals output from the processor to terminals, other base stations, or other entities through a wired or wireless network.

The storage 1515 may store a program and data necessary for the operation of the base station. In addition, the storage 1515 may store control information or data included in a signal acquired from the base station. The storage 1515 may be configured as storage media such as a ROM, a RAM, a hard disk, a CD-ROM, and a DVD, or a combination of storage media. In addition, the storage 1515 may store at least one of the information transmitted and received through the transceiver 1505 or the information generated through the controller 1510.

In the present disclosure, the controller 1510 may be defined as a circuit, an application-specific integrated circuit, or at least one processor. The processor may include a communication processor (CP) that performs control for communication and an application processor (AP) that controls higher layers such as application programs. The controller 1510 may control the overall operation of the base station according to the embodiment proposed in the present disclosure. For example, the controller 1510 may control a signal flow between each block to perform the operation according to the flowchart described above.

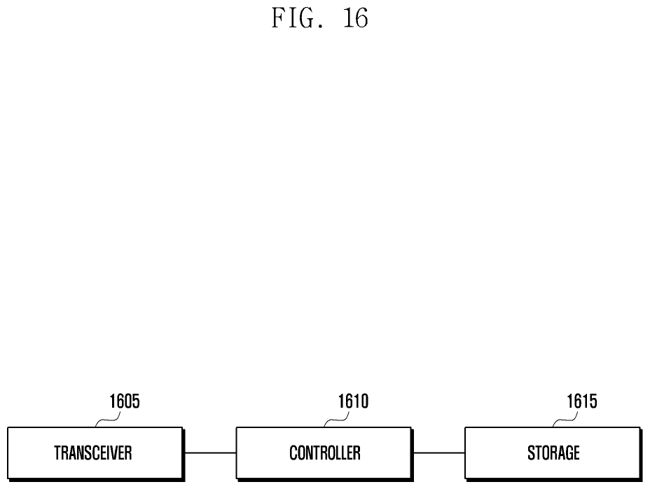

FIG. 16 is a diagram illustrating a structure of a terminal according to an embodiment of the present disclosure.

Referring to FIG. 16, the terminal may include a transceiver 1605, a controller 1610, and a storage 1615. According to the communication method of the terminal described above, the transceiver 1605, the controller 1610, and the storage 1615 may operate. However, the components of the terminal are not limited to the above-described examples. For example, the terminal may include more or fewer components than the above-described components. For example, the terminal may include the transceiver 1605 and the controller 1610. In addition, the transceiver 1605, the controller 1610, and the storage 1615 may be implemented in the form of a single chip.

The transceiver 1605 refers collectively to a receiver of the terminal and a transmitter of the terminal, and may transmit and receive a signal to and from base stations, other terminals, or other network entities. The signal transmitted and received to and from the base station may include control information and data. The transceiver 1605 may receive system information from the base station, for example, and receive a synchronization signal or a reference signal. To this end, the transceiver 1605 may be composed of an RF transmitter that up-converts a frequency of the transmitted signal and amplifies the transmitted signal, an RF receiver that low-noise amplifies the received signal and down-converts a frequency of the received signal, etc. However, this is only an embodiment of the transceiver 1605, and the components of the transceiver 1605 are not limited to the RF transmitter and the RF receiver. In addition, the transceiver 1605 may include a wired and wireless transceiver, and may include various components for transmitting and receiving a signal. In addition, the transceiver 1605 may receive a signal through a wireless channel, output the received signal to the controller 1610, and transmit a signal output from the controller 1610 through the wireless channel. In addition, the transceiver 1605 may receive a communication signal and output the received communication signal to a processor, and transmit the signal output from the processor to network entities through a wired or wireless network.

The storage 1615 may store a program and data necessary for the operation of the terminal. In addition, the storage 1615 may store control information or data included in a signal acquired from the terminal. The storage 1615 may be configured as storage media such as a ROM, a RAM, a hard disk, a CD-ROM, and a DVD, or a combination of storage media.

In the present disclosure, the controller 1610 may be defined as a circuit or an application-specific integrated circuit or at least one processor. The processor may include a communication processor (CP) that performs control for communication and an application processor (AP) that controls higher layers such as application programs. The controller 1610 may control the overall operation of the terminal according to the embodiment proposed in the present disclosure. For example, the controller 1610 may control a signal flow between each block to perform the operation according to the flowchart described above.

Methods according to the embodiments described in the claims or specifications of the present disclosure may be implemented in the form of hardware, software, or a combination of hardware and software.

When implemented in software, a computer-readable storage medium storing one or more programs (software modules) may be provided. One or more programs stored in the computer-readable storage medium are configured to be executable by one or more processors in an electronic device. One or more programs include instructions for causing an electronic device to execute methods according to embodiments described in a claim or specification of the present disclosure.

Such programs (software module, software) may be stored in a random access memory, a non-volatile memory including flash memory, a read only memory (ROM), an electrically erasable programmable read only memory (EEPROM), a magnetic disc storage device, a compact disc-ROM (CD-ROM), digital versatile discs (DVDs), any other form of optical storage device, and a magnetic cassette. Alternatively, the programs may be stored in a memory composed of a combination of some or all thereof. In addition, each configuration memory may be included in plurality.

In addition, the program may be stored in an attachable storage device that may accessed via a communication network such as the Internet, the Intranet, a local area network (LAN), wide LAN (WLAN), or a storage area network (SAN), or a combination thereof. Such a storage device may be connected to a device implementing an embodiment of the present disclosure through an external port. In addition, a separate storage device on the communication network may be connected to the device implementing the embodiment of the present disclosure.

In the specific embodiments of the present disclosure described above, components included in the present disclosure are expressed in the singular or plural according to the specific embodiments presented. However, the singular or plural expression is appropriately selected for the context presented for convenience of description, and the present disclosure is not limited to the singular or plural components, and even if the component is expressed in plural, the component is configured in singular or even if the component is expressed in singular, the component may be configured in plural.

Meanwhile, although specific embodiments have been described in the detailed description of the present disclosure, various modifications are possible without departing from the scope of the present disclosure. Therefore, the scope of the present disclosure is not construed as being limited to the embodiments described above, but should be defined by the following claims as well as equivalents thereto.

1. A method performed by a terminal in a wireless communication system, comprising:
receiving, from a base station, a first measurement configuration including information on a number of triggering cells satisfying an event to trigger measurement report;
performing the measurement report based on the information on the number of triggering cells in case that the event is satisfied for at least one cell;
receiving, from the base station, a second measurement configuration including information indicating that a measurement reporting entry is not removed; and
performing measurement based on the second measurement configuration,
wherein the measurement reporting entry is not removed based on the information.

2. The method of claim 1, wherein performing the measurement report further comprises performing the measurement report in case that a number of the at least one cell is larger than the number of triggering cells.

3. The method of claim 1, wherein the first measurement configuration includes a cell list for the measurement report, and
wherein performing the measurement report further comprises, in case that the event is satisfied for a cell included in the cell list, in case that a number of the at least one cell is larger than the number of triggering cells when the event is satisfied for the cell included in the cell list, or in case that a number of cells included in the cell list among the cells satisfying the event is larger than the number of triggering cells, the measurement report is performed.

4. The method of claim 1, wherein the second measurement configuration includes information indicating that the terminal initiates the measurement reporting procedure in case that a leaving condition is satisfied for a cell is set to TRUE, and
in case that the leaving condition is satisfied for the at least one cell among the cells satisfying the event, the measurement report is performed.

5. A method performed by a base station in a wireless communication system, comprising:
transmitting, to a terminal, a first measurement configuration including information on a number of triggering cells satisfying an event to trigger measurement report;
receiving, from the terminal, the measurement report based on the information on the number of triggering cells in case that the event is satisfied for at least one cell; and
transmitting, to the terminal, a second measurement configuration including information indicating a measurement reporting entry is not removed.

6. The method of claim 5, wherein in case that a number of the at least one cell is larger than the number of triggering cells, the measurement report is received.

7. The method of claim 5, wherein the first measurement configuration includes a cell list for the measurement report, and
in case that the event is satisfied for a cell included in the cell list, in case that a number of the at least one cell is larger than the number of triggering cells when the event is satisfied for the cell included in the cell list, or in case that the number of cells included in the cell list among the cells satisfying the event is larger than the number of triggering cells, the measurement report is received.

8. The method of claim 5, wherein the second measurement configuration includes information indicating that the terminal initiates the measurement reporting procedure in case that a leaving condition is satisfied for a cell is set to TRUE, and
in case that the leaving condition is satisfied for the at least one cell among the cells satisfying the event, the measurement report is received.

9. A terminal in a wireless communication system, comprising:
a transceiver; and
a controller coupled with the transceiver and configured to:
receive, from a base station, a first measurement configuration including information on a number of triggering cells satisfying an event to trigger measurement report,
perform the measurement report based on the information on the number of triggering cells in case that the event is satisfied for at least one cell,
receive, from the base station, a second measurement configuration including information indicating that a measurement reporting entry is not removed, and
perform measurement based on the second measurement configuration, and
the measurement reporting entry is not removed based on the information.

10. The terminal of claim 9, wherein, in case that a number of the at least one cell is larger than the number of triggering cells, the controller is configured to perform the measurement report.

11. The terminal of claim 9, wherein the first measurement configuration includes a cell list for the measurement report, and
when the event is satisfied for a cell included in the cell list, in case that a number of the at least one cell is larger than the number of triggering cells when the event is satisfied for the cell included in the cell list, or in case that a number of cells included in the cell list among the cells satisfying the event is larger than the number of triggering cells, the controller is configured to perform the measurement report.

12. The terminal of claim 9, wherein the second measurement configuration includes information indicating that the terminal initiates the measurement reporting procedure in case that a leaving condition is satisfied for a cell is set to TRUE, and
when the leaving condition is satisfied for the at least one cell among the cells satisfying the event, the measurement report is performed.

13. A base station in a wireless communication system, comprising:
a transceiver; and
a controller coupled with the transceiver and configured to:
transmit, to a terminal, a first measurement configuration including information on a number of triggering cells satisfying an event to trigger measurement report,
receive, from the terminal, a measurement reporting entry based on the information on the number of triggering cells in case that the event is satisfied for at least one cell, and
transmit, to the terminal, a second measurement configuration including information indicating that the measurement reporting entry is not removed.

14. The base station of claim 13, wherein the first measurement configuration includes a cell list for the measurement report, and
the measurement report is received in case that a number of the at least one cell is larger than the number of triggering cells, in case that the event is satisfied for a cell included in the cell list, or in case that a number of the at least one cell is larger than the number of triggering cells when the event is satisfied for the cell included in the cell list, or in case that a number of cells included in the cell list among the cells where the event is satisfied is larger than the number of triggering cells.

15. The base station of claim 13, wherein the second measurement configuration includes information indicating that the terminal initiates the measurement reporting procedure in case that a leaving condition is satisfied for a cell is set to TRUE, and
in case that the leaving condition is satisfied for the at least one cell among the cells satisfying the event, the measurement report is received.
